(19) United States
(12) Patent Application Publication
(10) Pub. No.: US 2010/0179075 A1
(43) Pub. Date: Jul. 15, 2010

(54) PARTICLES FOR USE IN SUPPORTED NUCLEIC ACID LIGATION AND DETECTION SEQUENCING

(75) Inventors: Aldrich N.K. LAU, Palo Alto, CA (US); Mark F. OLDHAM, Los Gatos, CA (US)

Correspondence Address: LIFE TECHNOLOGIES CORPORATION;C/O INTELLEVATE, P.O. BOX 52050, MINNEAPOLIS, MN, 55402, US

(73) Assignee: LIFE TECHNOLOGIES CORPORATION, Carlsbad, CA (US)

(21) Appl. No.: 12/512,639

(22) Filed: Jul. 30, 2009

Related U.S. Application Data
(60) Provisional application No. 61/084,701, filed on Jul. 30, 2008.

(51) Int. Cl. C40B 50/18

(52) U.S. Cl. 506/32

(57) ABSTRACT

Compositions and methods to modify the surface of particles to which biomolecules are attached are disclosed. The particles can include beads and nanoparticles which are composed of metallics, metal alloys, glass, polymers and derivatives and composites thereof. The surface of the particles are modified to be hydrophilic for ease in the attachment of biomolecules to the particle surface and immobilization of the particles to a substrate to facilitate process such as nucleic acid sequencing, PCR and sequencing by ligation.

This application claims priority to U.S. Provisional Application No. 61/084,701, filed Jul. 30, 2008, the entirety of which is incorporated herein by reference.

### FIELD

Compositions and methods to modify the surface of particles to which biomolecules are attached.

### INTRODUCTION

High throughput sequencing technologies often include the attachment of oligonucleotides to the surface of a particle to facilitate arraying of the oligos on a glass microscope slide. The slide acts as the substrate on which to immobilize the particle and subsequent analysis, e.g., DNA sequencing or SNP detection. Current particle immobilization methods utilize biotin/strep bioconjugation as a method for immobilization of particles/beads used in sequencing by ligation methodologies. However, the unreacted biotin or streptavidin groups can lead to aggregation of particles and loss of efficiency when the particles are arrayed on the slide. Thus, there remains a need in the art to improve the immobilization of beads and enhance the reaction signals of the attached biomolecules.

### SUMMARY

Disclosed are methods and composition having a hydrophilic surface that include providing at least one substrate particle surface; chemically modifying the surface; reacting the modified surface with at least one functionalized poly(ethylene oxide); wherein a hydrated poly(ethylene oxide) substrate particle surface is formed. In various embodiments the surface is cleaned with a Piranha Solution or by sonicating (a) in a solution including a 1:1:4 v/v of NH₃ (29%), H₂O₂ (30%) and deionized water, and then subsequently (b) in a solution including a 1:1:4 v/v of HCl (38%), H₂O₂ (30%), and deionized water.

In further embodiments the substrate particle surface is selected from the group consisting of a spherical, a planar, or an undulating surface and irregular forms thereof and the spherical surface is selected from the group consisting of a bead, a rhombus or irregular shapes thereof. The bead can have a size of at least 0.5 to 10 microns and be solid or porous wherein a pore has a sized of at least 100 Å to 1000 nanometers and a porosity of at least 10% to 95%.

In various embodiments the bead is a polymer selected from the group consisting of a homopolymer, a copolymer, or a blend of at least one homopolymer and/or at least one copolymer and the polymer is selected from a linear, branched, dendritic or star-bursted polymer. The polymer can be non-crosslinked or crosslinked. The bead can also be selected from the group consisting of glass, soda lime glass, silica dioxide, fused silica, and quartz.

In other embodiments the at least one functionalized poly(ethylene oxide) is selected from the group consisting of mPEG-NHS, MAL-PEG-NHS, and NHS-PEG-NHS, wherein the mPEG-NHS is a C₆ to C₂₀₀ chain molecule, a C₂₀ to C₁₅₀ chain molecule, or a C₈₀ to C₁₂₀ chain molecule. Prior to the PEGylating of the particle surface the surface undergoes a chemical modification such as silyation or thiolation.

In various embodiments there is disclosed a method of immobilizing a bead to a substrate including: providing at least one bead with a clean surface; silylating the bead surface; reacting the silylated bead surface with at least one poly(ethylene oxide), wherein a hydrated poly(ethylene oxide) bead surface is formed; providing a functionalized substrate surface; reacting the functionalized substrate with the hydrated poly(ethylene oxide) bead surface; wherein the bead is immobilized to the substrate. The functionalized substrate surface can be metal, a metal alloy, glass, silica, polymer, a copolymer and the like and/or combinations and derivatives thereof. For embodiments using a glass substrate as the surface substrate, the glass can be reacted with a cyclopentadiene agent or a silane agent. The cyclopentadiene agent results in the formation of a cyclopentadiene-functionalized glass substrate surface and can react with the terminal maleimide group of the poly(ethylene oxide), wherein the bead is immobilized to the glass substrate. The glass bead can be immobilized by undergoing an amidation reaction with at least one of the NHS groups in the functionalized poly(ethylene oxide) with at least one of the amino groups on the amine-functionalized substrate surface.

In certain embodiments the method can include magnetic, paramagnetic and super paramagnetic particles. The material of the magnetic, paramagnetic and super paramagnetic particles can be iron, nickel, cobalt and alloys thereof, samarium, and neodium, from 1 to 100 nanometers, including 2 to 20 nanometers in size and the magnetic, paramagnetic and super paramagnetic particles can be trapped, embedded, attached and/or adhered in/onto the glass or polymeric particle.

In certain embodiments attached to the hydrophilic bead surface is a biomolecule. The biomolecule can be an oligonucleotide, a bioconjugate or an enzyme.

In various embodiments there is disclosed a method of forming a hydrophilic surface on a particle having a surface plasmon resonance comprising providing at least one substrate particle surface; chemically modifying the surface; reacting the modified surface with at least one functionalized poly(ethylene oxide); wherein a hydrated poly(ethylene oxide) substrate particle surface is formed. The plasmon resonance is formed by: attaching a plurality of linker molecules to the substrate particle; attaching a preformed metal nanoparticle to each of at least a portion of said linker molecules; reducing additional metal onto the metal particles so as to form a substantially continuous metal shell encapsulating each substrate particle; and selecting the conditions of reducing the additional metal onto the metal particles such that the shell has a controllable thickness. The metal shell is chemically modified with at least one functionalized poly(ethylene oxide) and attached to at least one functionalized poly(ethylene oxide) is a biomolecule.

In certain embodiments the metal shell comprises a metal selected from the group consisting of the coinage metals, noble metals, transition metals, and synthetic metals. The metal shell is chemically modified with functionalized poly(ethylene oxide) selected from the group consisting of mPEG-NHS, MAL-PEG-NHS, and NHS-PEG-NHS, wherein the mPEG-NHS is a C₆ to C₂₀₀ chain molecule, a C₂₀ to C₁₅₀ chain molecule, or a C₈₀ to C₁₂₀ chain molecule. Prior to the PEGylating of the particle surface the surface undergoes a chemical modification such as silyation or thiolation.

In one embodiment, disclosed is particle having a functionalized hydrophilic surface of a compound of the formula:

A-PEG-B

wherein A and B are independently selected from the group consisting of NHS, MAL, carboxy, mercapto, methoxy, amino, acryloyloxy, epoxy and biotin; and PEG is a compound of the formula:

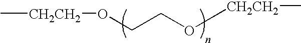

or a mixture of two PEG compounds with two n ranges, wherein n is 6 to 200 repeat units. The particle can have attached to the functionalized hydrophilic surface a biomolecule selected from an oligonucleotide, a bioconjugate and an enzyme. The oligonucleotide can be at least one primer used in an emulsion polymerase chain reaction.

In certain embodiments, the particle can have a surface which includes a plasmon resonance formed by attaching a plurality of linker molecules to the substrate particle; attaching a preformed metal nanoparticle to each of at least a portion of said linker molecules; reducing additional metal onto the metal particles so as to form a substantially continuous metal shell encapsulating each substrate particle; and selecting the conditions for reducing metal onto the metal particles such that the shell has a controllable thickness.

The particle surface having plasmon resonance can include a functionalized hydrophilic surface comprising a compound of the formula:

A-PEG-B

wherein A and B are independently selected from the group consisting of NHS, MAL, carboxy, mercapto, methoxy, amino, acryloyloxy, epoxy and biotin and PEG is a compound of the formula:

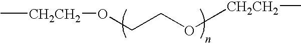

or a mixture of two PEG compounds with two n ranges, wherein n is 6 to 200 repeat units. Attached to the A-PEG-B compound can be at least one nucleic acid and/or a biomolecule selected from the group consisting of an oligonucleotide, a bioconjugate and an enzyme. The oligonucleotide can be at least one primer used in an emulsion polymerase chain reaction.

In one embodiment, a particle surface having a plasmon resonance is formed by providing a clean particle surface; applying a metal by vapor deposition wherein the surface comprises a metallic shell. The surface can also include a functionalized hydrophilic surface comprising a compound of the formula:

A-PEG-B

wherein A and B are independently selected from the group consisting of NHS, MAL, carboxy, mercapto, methoxy, amino, acryloyloxy, epoxy and biotin; PEG is a compound of the formula:

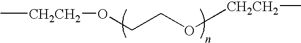

or a mixture of two PEG compounds with two n ranges, wherein n is 6 to 200 repeat units attached to the A-PEG-B compound can be at least one nucleic acid and/or a biomolecule and/or a biomolecule selected from the group consisting of an oligonucleotide, a bioconjugate and an enzyme. The oligonucleotide can be at least one primer used in an emulsion polymerase chain reaction.

In on embodiment a method of forming a hydrophilic surface is described including providing at least one substrate particle surface; chemically modifying the surface; reacting the modified surface with at least one functionalized poly(ethylene oxide); wherein a hydrated poly(ethylene oxide) substrate particle surface is formed. The surface can be cleaned by soaking in a solution such as Piranha Solution and through sonicating. Sonication can be in a solution comprising a 1:1:4 v/v of NH₃ (29%), H₂O₂ (30%), and deionized water.

The substrate particle surface is selected from the group including a spherical, a planar, or an undulating surface and irregular forms thereof and the spherical surface is selected from the group consisting of a bead, a rhombus or irregular shapes thereof. The bead can have a size of at least 0.5 to 10 microns, be solid or porous with a pore having a size of at least 100 Å to 1000 nanometers and a porosity of at least 10% to 95%.

The bead can be of a material such as glass, soda lime glass, silica, silica dioxide, and quartz or a polymer selected from the group including a homopolymer, a copolymer, or a blend of at least one homopolymer and/or at least one copolymer and the polymer is selected from a linear, branched, dendritic or star-bursted polymer and be non-crosslinked or crosslinked. The polymer can also contain magnetic, paramagnetic or super paramagnetic iron particles 5 to 100 nanometers in size trapped, embedded, attached and/or adhered in/onto the polymer.

The at least one functionalized poly(ethylene oxide) used in the method of forming a hydrophilic surface can be selected from the mPEG-NHS, MAL-PEG-NHS, MAL-PEG-MAL, and NHS-PEG-NHS and the PEG is a C₆ to C₂₀₀ chain molecule, a C₂₀ to C₁₅₀ chain molecule or a C₈₀ to C₁₂₀ chain molecule or a combination thereof. The at least one functionalized poly(ethylene oxide) as MAL-PEG-NHS can have a PEG with a C₆ to C₁₂₀ chain molecule and/or a C₁₀₀ to C₁₃₀ chain molecule and combinations thereof.

The method of forming a hydrophilic surface on a particle can include chemical modification of the particle surface by silyation and the sonicating is performed in a solution comprising a 1:1:4 v/v of HCl (38%), H₂O₂ (30%) and deionized water.

The method of forming a hydrophilic surface on a particle can include at least one functionalized poly(ethylene oxide) selected from MAL-PEG-MAL, mPEG-MAL, mPEG-MAL and MAL-PEG-MAL. Attached to the at least one functionalized poly(ethylene oxide) compound can be at least one nucleic acid and/or a biomolecule and/or a biomolecule selected from the group consisting of an oligonucleotide, a bioconjugate and an enzyme. The oligonucleotide can be at least one primer used in an emulsion polymerase chain reaction.

In a certain embodiment, described is a method of immobilizing a bead to a substrate including: providing at least one bead with a clean surface; silylating the bead surface; reacting the silylated bead surface with at least one poly(ethylene oxide), wherein a hydrated poly(ethylene oxide) bead surface is formed and then providing a functionalized substrate surface and reacting the functionalized substrate's surface with the hydrated poly(ethylene oxide) bead surface wherein the bead is immobilized to the substrate. The poly(ethylene oxide) can be selected from mPEG-NHS, MAL-PEG-NHS, MAL-PEG-MAL, and NHS-PEG-NHS and so on. For embodiments using a glass substrate as the surface substrate, the glass can be reacted with a cyclopentadiene agent, wherein a cylopentadiene-functionalized glass substrate surface having a maleimide group is formed and the maleimide group reacts with the poly(ethylene oxide) bead surface. The reaction of the cyclopentadiene agent with the maleimide group of the MAL-PEG-NHS immobilizes the bead to the glass substrate. The glass surface can also be reacted with a silane agent forming an amine-functionalized glass substrate which upon undergoing an amidation reaction with at least one of the NHS groups in the NHS-PEG-NHS, forms an amine-functionalized substrate surface.

The method of immobilizing a bead to a substrate can include at least one hydrated functionalized poly(ethylene oxide) selected from MAL-PEG-MAL, mPEG-MAL, mPEG-MAL and MAL-PEG-MAL attached to the bead surface. Attached to the at least one functionalized poly(ethylene oxide) compound can be at least one nucleic acid and/or a biomolecule and/or a biomolecule selected from the group consisting of an oligonucleotide, a bioconjugate and an enzyme. The oligonucleotide can be at least one primer used in an emulsion polymerase chain reaction.

In one embodiment, the invention relates to a kit for forming a functionalized particle with a biomolecule attached including at particle, a colloidal metal solution, a hydrolated PEG mixture, and a control biomolecule. The kit may include reagents and instructions necessary for amplification of one or more subsets of nucleic acid fragments.

In one embodiment, the invention relates to a method for selectively attaching particles to a substrate surface, the method further comprising: providing a substrate surface configured to receive a plurality of particles; introducing the plurality of particles onto the substrate surface; and immobilizing the plurality of particles to the substrate surface by a selectively triggered reaction.

The method for selectively triggering immobilization of the plurality of particles to the substrate surface may be effectuated following ordering of the particles on the substrate surface in a desired particle configuration.

The method may further comprise a step in which prior to selectively triggering immobilization of the plurality of particles to the substrate surface the position of the particles is manipulated, additional particles are added to the substrate surface, or particles are removed from the substrate surface to achieve the desired particle configuration.

The method for selectively triggered reaction may further comprise a click reaction wherein furthermore the click reaction may be based on a mechanism selected from the group consisting of: copper-based catalytic reactions, thermally triggered reactions, difluorinated cyclooctyne-based reactions, hydrophilic azacyclooctyne-based reactions, and azide-alkyne cycloaddition covalent modification reactions.

Additionally the method for selectively triggered immobilization of the plurality of particles to the substrate surface may further result in an ordered array of particles.

In the following description, certain aspects and embodiments will become evident. It should be understood that a given embodiment need not have all aspects and features described herein. It should be understood that these aspects and embodiments are merely exemplary and explanatory and are not restrictive of the invention.

It is to be understood that both the foregoing general description and the following detailed description are exemplary and explanatory only and are not restrictive of the invention, as claimed.

The accompanying drawings, which are incorporated in and constitute a part of this specification, illustrate several exemplary embodiments of the disclosure and together with the description, serve to explain certain teachings.

One disadvantage in next generation sequencing methodologies typically involves aggregation of the particles (beads) both in the emulsion and following the breaking of the emulsion. Improvements in signal detection rate and improvements in sensitivity will increase throughput and accuracy. There still exists a need in the art for improved sequencing systems and methods which increase read length, accuracy and throughput in conjunction with decreased cost per base.

These and other features of the present teachings are set forth herein.

### BRIEF DESCRIPTION OF THE DRAWING

The skilled artisan will understand that the drawings described below are for illustration purposes only. The drawings are not intended to limit the scope of the present teachings in any way.

FIG. 1 illustrates a glass bead surface undergoing silylation and attachment of functionalized PEG.

FIG. 2 illustrates attachment of a biomolecule conjugate to a glass bead followed by immobilization of the bead to a substrate surface.

FIG. 3 illustrates attachment of a biomolecule conjugate to a glass bead followed by immobilization of the bead to an amine-functionalized substrate surface.

FIG. 4 illustrates attachment of a biomolecule conjugate to a glass bead having a thiolate functionalized bead surface.

FIG. 5 illustrates attachment of a biomolecule conjugate to a glass bead having a cyclopentadienyl functionalized bead surface.

FIG. 6 illustrates attachment of a biomolecule conjugate to a glass bead having a epoxysilane functionalized bead surface via Click Chemistry I.

FIG. 7 illustrates attachment of a biomolecule conjugate to a glass bead having an acetylyne or triazide functionalized substrate surface using Click Chemistry II.

FIG. 8 schematically illustrates plasmon resonance surrounding a particle.

FIG. 9A is a schematic representation of a rough particle surface.

FIG. 9B is a schematic representation of a continuous particle surface.

FIG. 9C is a schematic representation of a discontinuous particle surface.

### DETAILED DESCRIPTION

For the purposes of interpreting this specification; the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used). It is noted that, as used in this specification and the appended claims, the singular forms “a,” “an,” and “the,” include plural referents unless expressly and unequivocally limited to one referent. The use of “or” means “and/or” unless stated otherwise. The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of and/or “consisting of.”

Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible subranges as well as common rational numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, 1.16 to 3.011, etc., as well as all rational numbers within that range. The same holds true for ranges in increments of 10⁵, 10⁴, 10³, 10², 10, 10⁻¹, 10⁻², 10⁻³, 10⁻⁴, or 10⁻⁵, for example. This applies regardless of the breadth of the range

The section headings used herein are for organizational purposes only and are not to be construed as limiting the subject matter described. All documents, or portions of documents, cited in this application, including but not limited to patents, patent applications, articles, books, and treatises are hereby expressly incorporated by reference in their entirety for any purpose. In the event that one or more of the incorporated documents defines a term that contradicts that term's definition in this application, this application controls.

As used herein, the terms “bead”, “particle” and nanoparticle are interchangeable.

As used herein, the term “bioconjugation” refers to the process of coupling two biomolecules by a covalent bond. It can also apply to the coupling of a biomolecule with a synthetic molecule.

As used herein, the term “biomolecule” refers to a chemical compound either synthetic, naturally occurring or chemically modified for example, but not limited to, nucleobases, nucleic acids, polynucleotides, oligonucleotides, polypeptides, carbohydrates, antibodies, phage proteins, biotins, streptavidins, ligands, smart polymers as well as polymeric biomolecules (e.g.—proteins, peptide nucleic acids (PNAs), locked nucleic acids (LNAs), PNA-DNA chimeras, and the like), amino acid monomers, nucleotide monomers, and small molecules, and the like. For examples of bioconjugation of biomolecules, reference is made to Greg T. Hermanson, “Bioconjugation Techniques,” Academic Press, 1996, the disclosure of which is hereby incorporated by reference.

As used herein, the term “clean surface” refers to a surface substantially or totally free of impurities and oxidation build-up.

As used herein, the term “coating” refers to a discrete entity encapsulated on a continuous substrate e.g. a polymer with iron crystallite particles where the polymer is the continuous substrate and the iron crystallite is the discrete entity.

As used herein, the term “dielectric” refers to a nonconductor, without applying a specific conductivity. The dielectric can have milli-Siemens/cm conductivity in the presence of mM salt concentrations. The metal has at least 3 orders of magnitude of conductivity in comparison to the dielectric.

The term “immobilized” is art-recognized and, when used with respect to a particle, refers to a condition in which the particle is attached to a surface with an attractive force stronger than attractive, shear and/or surface energy forces that are present in the intended environment of use of the surface, and that act on the particle. The attachment to a surface can be by non-specific adsorption due to, for example, but not limited to, a hydrophobic-hydrophobic interaction, a hydrophobic-hydrophilic interaction, and a dipole-dipole interaction. In various embodiments of the present teachings, the attachment to a surface can be by the formation of a covalent bond or an ionic bond. In some embodiments of the present teachings, the attachment can be effected by the formation of a plurality of covalent bonds, ionic bonds, or a combination thereof.

As used herein, the term “linker” refers to a chemical entity that is capable of covalently binding at least two chemical entities, at least two biomolecules, or at least one chemical entity and at least one biomolecule together. The chemical entity can include at least two functional groups. The functional group can be, for example, but not limited to, a cyclopentadienyl group, an acetylene group, a mercapto group, a N-hydroxysuccinimidyl ester group, or a maleimide group. The chemical entity can be a telechelic oligomer or telechelic polymer that is at least partially soluble in water. The chemical entity can comprise an oligonucleotide, a polyelectrolyte, or a repeat unit of, for example, but not limited to, ethylene oxide, propylene oxide, N-vinylpyrrolidone, N-vinylamide, and acrylamide.

As used herein, the phrase “nucleic acid,” “oligonucleotide”, “polynucleotide(s)” and “oligomer” are interchangeable.

As used herein, the term “plasmon” refers to collective oscillations of free electrons at optical frequencies that travel across a metallic surface. Plasmons on the surface of a nanoparticle are light which has been converted into electrical energy when the frequency of the light resonates with the frequency of the plasmon's oscillation.

As used herein, “plasmon resonance” can be defined as a collective oscillation of free electrons or plasmons at optical frequencies.

As used herein, “surface plasmons” are those plasmons that are confined to surfaces and that interact strongly with light resulting in a polariton. They occur at the interface of a material with a positive dielectric constant with that of a negative dielectric constant (usually a metal or doped dielectric).

As used herein, “resonant structure” can refer to a structure such as a nano-antenna or nanoparticle that use plasmon resonance along with shape of the structure to concentrate light energy to create a small zone of high local field.

As used herein, the terms “polynucleotide”, “nucleic acid”, or “oligonucleotide” refers to a linear polymer of natural or modified monomers or linkages, including deoxyribonucleosides, ribonucleosides, polyamide nucleic acids, and the like, joined by inter-nucleosidic linkages and have the capability of specifically binding to a target polynucleotide by way of a regular pattern of monomer-to-monomer interactions, such as Watson-Crick type of base pairing, and capable of being ligated to another oligonucleotide in a template-driven reaction. Usually monomers are linked by phosphodiester bonds, e.g. 3′-5′ and 2′-5′, inverted linkages, e.g. 3′-3′ and 5′-5′, branched structures, or analogs thereof to form oligonucleotides ranging in size from a few monomeric units, e.g. 3-4, to several hundreds of monomeric units. Polynucleotides have associated counter ions, such as H⁺, NH₄⁺, trialkylammonium, Mg²⁺, Na⁺ and the like. A polynucleotide can be composed entirely of deoxyribonucleotides, entirely of ribonucleotides, or chimeric mixtures thereof. Polynucleotides can include nucleobase and sugar analogs. Polynucleotides typically range in size from a few monomeric units, e.g. 5-40 when they are more commonly frequently referred to in the art as oligonucleotides, to several thousands of monomeric nucleotide units. Whenever a polynucleotide such as an oligonucleotide is represented by a sequence of letters, such as “ATGCCTG,” it will be understood that the nucleotides are in 5′→3′ order from left to right and that “A” denotes deoxyadenosine, “C” denotes deoxycytidine, “G” denotes deoxyguanosine, and “T” denotes deoxythymidine, unless otherwise noted. The letters A, C, G, and T can be used to refer to the bases themselves, to nucleosides, or to nucleotides comprising the bases, as is standard in the art. In naturally occurring polynucleotides, the inter-nucleoside linkage is typically a phosphodiester bond, and the subunits are referred to as “nucleotides.”

Reference will now be made to various embodiments, examples of which are illustrated in the accompanying drawings.

For simplicity and illustrative purposes, the principles of the present invention are described by referring mainly to exemplary embodiments thereof. However, one of ordinary skill in the art would readily recognize that the same principles are equally applicable to, and can be implemented in, all types of detection systems, and that any such variations do not depart from the true spirit and scope of the present invention. Moreover, in the following detailed description, references are made to the accompanying figures, which illustrate the disclosed embodiments. Electrical, mechanical, logical and structural changes may be made to the embodiments without departing from the spirit and scope of the present teachings. The following detailed description is, therefore, not to be taken in a limiting sense and the scope of the present teaching is defined by the appended claims and their equivalents.

In various embodiments the particle can be a solid material. The particle can include, for example, a material such as, but not limited to a metal including but not limited to gold, silver, palladium, platinum, aluminum, lead, iron, copper and alloys thereof, indium-tin oxide (ITO), coinage metals, noble metals, transition metals, synthetic metals, and alloys thereof, diamond, carbon nanotube, and the like, metal oxide, metal halide, metal hydroxide, metal alloy, silicon, silicon dioxide, fused silica, quartz, glass, glassy carbon, carbon, polymer, or blends and combinations thereof. The particle can have an irregular shape or a regular shape selected from a sphere, a rhombus, a bead, a disc, a cube, a pyramid, a polyhedron and irregular shapes thereof. The particle can also be magnetic and further comprise an oligonucleotide attached to the particle. The particle can be magnetic, paramagnetic or super paramagnetic. The size of the particle can range from 0.025 to 10 microns. The particles can be solid or porous with a pore size ranging from 100 Å to 1000 nanometers and a porosity of 10% to 95%.

The particle can be made of a polymer, homopolymer or a copolymer, or a blend of at least two homopolymers and/or at least two copolymers. The polymer can be linear, branched, dendritic or star-bursted. The polymer can be non-crosslinked or crosslinked. Exemplary polymers include but are not limited to, polystyrene, poly(ether sulfone), polyester, polycarbonate, polyimide, polyimide, polyacrylate, polymethacrylate, fluorinated and perfluorinated polymers, and copolymers and blends thereof. The particle can have magnetic, paramagnetic or super paramagnetic particles, including iron, nickel, cobalt and alloys thereof, samarium, and neodium, from 1 to 100 nanometers in size trapped, embedded, attached and/or adhered in/onto the polymeric particle.

The particle can also be made of a metal, for example but not limited to, stainless steel or another metal alloy, coinage metals, noble metals, transition metals, aluminum, synthetic metals and alloys thereof and indium-tin oxide (ITO). The particle can also be made of silicon. The particle can also be a silica or alumina particle (e.g., made by sintering silica or alumina powders) or a porous ceramic particle. The particle can also be a semi-conductive material, for example but not limited to, nicrosil, nisil, germanium, silicon germanium, silicon carbide, gallium arsenide, gallium nitride, indium phosphide, cadmium telluride (CdTe), cadmium selenide/zinc sulfide (CdSe/ZnS), lead selenide (PbSe) and zinc cadmium selenide/zinc sulfide (ZnCdSe/ZnS), zinc oxide (ZnO), and cadmium sulfide (CdS), and the like.

The particle can be made of glass such as, for example but not limited to, soda lime glass, silica, and quartz. The glass particle can also be porous and can also have magnetic, paramagnetic or super paramagnetic particles from 1 to 100 nanometers in size trapped, embedded, attached and/or adhered in/onto the glass particle.

The particle can include a core surrounded by a solid material. The core can have a uniform or a composite composition. The composition of the core can include, for example, a material such as, but not limited to a metal, metal oxide, metal halide, metal hydroxide, metal alloy, silicon, silicon dioxide, fused silica, glass, glassy carbon, carbon, polymer, or blends and combinations thereof, iron, magnetic, paramagnetic and super paramagnetic. The core can be magnetic, paramagnetic or super paramagnetic. The core can have an irregular shape or a regular shape such as a sphere, a rhombus, cube, cylinder, hemisphere or irregular shapes thereof. The size of the core can range from 15 nm to 1 micron.

The particle can be surrounded by a coating. The coating can prevent oxidation of the material immediately below the coating. The coating can be made of chromium oxide, titanium oxide, a polymer, silicon dioxide and the like.

The surface of the particle can be physically or chemically modified. The surface can be smooth, porous, rough, etched, undulating and the like. For example, the surface of the particles can be physically modified by etching.—One of skill in the art is versed in the various techniques and methods to impart texture to a particle surface. For example, etching can occur by chemical or photochemical means. In another embodiment, the particle surface can be rough and the attached metallic layer follows the irregularities of the rough particle surface. The metallic layer atop the irregular particle surface is at least 5 to 15 nanometers, at least 10 to 20 nanometers and at least 15 to 40 nanometers in thickness. In yet another embodiment, the metallic layer atop a particle surface can be from 5 to 30, from 25 to 50, from 40 to 75, from 50 to 100 and from 75 to 200 nanometers in thickness. These ranges should be considered to have specifically disclosed all the possible subranges as well as common rational numerical values within that range. This applies regardless of the breadth of the range.

The particle surface can be chemically modified to include a linker molecule having a functional group projecting away from the surface of the particle to facilitate attachment of an oligonucleotide to the particle, attachment of the particle to a substrate or binding of a metallic material to the particle surface such that it substantially surrounds the particle. Examples of linker molecules useful in the attachment of an oligonucleotide include but are not limited to a cyclopentadienyl group, an acetylene group, a mercapto group, an N-hydroxysuccinimidyl ester group, a maleimide group, and the like. Linker molecules which can bind the particle to the surface of a substrate, such as an array, include but are not limited to a mercapto group, a disulfide group, a mono-, di-, or tri-alkoxysilyl group, and the like.

Metallic materials, bound to the surface of the particle via linkers, include for example but are not limited to coinage metals, noble metals, transition metals, aluminum, synthetic metals and alloys thereof and indium-tin oxide (ITO).

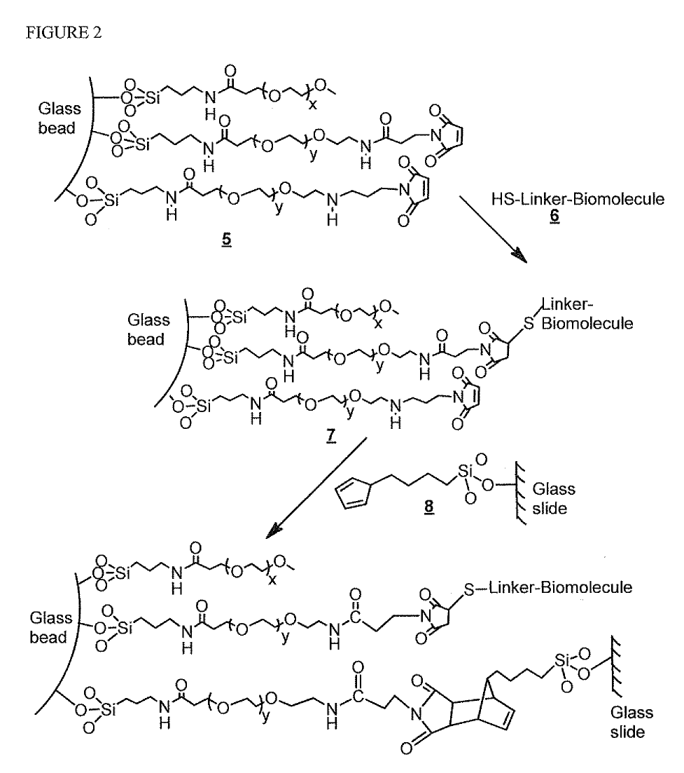

The surface of the particle can further include immobilized oligonucleotides. The immobilized oligonucleotides can serve, for example, as PCR primers in emulsion PCR (ePCR) reactions. ePCR is further described in, for example, S. C. Schuster, Nature Methods 5:16-18 (2007) and Albert et. al., Nature Methods 4:903-905 (2007). The surface of the particles can also be modified to contain other reactive groups for subsequent reactions such as, for example, bio-conjugation. The surface of the particles can also be modified for attachment to an array by covalent or non-covalent bonds. As shown in FIG. 2, the tethered maleimide groups on the particle surface serve two functions; bioconjugation with 6 for anchoring oligonucleotides to the particle and reaction with 8 to immobilize the particle onto the surface, e.g. a microarray. The surface of the particle can be physically or chemically modified to tailor its hydrophilicity.

### Chemical Means to Achieve Hydrophilic Particle Surfaces

In one embodiment the particle surface can be chemically or physically modified to render the surface hydrophilic. For example, chemically treating the surface of e.g., a glass particle by silylation to introduce surface amino groups which can further be reacted with functionalized PEGs such as mPEG-NHS and MAL-PEG-NHS to allow the particles to be available for bioconjugation and surface immobilization. Exemplary functionalized PEG structures are illustrated below:

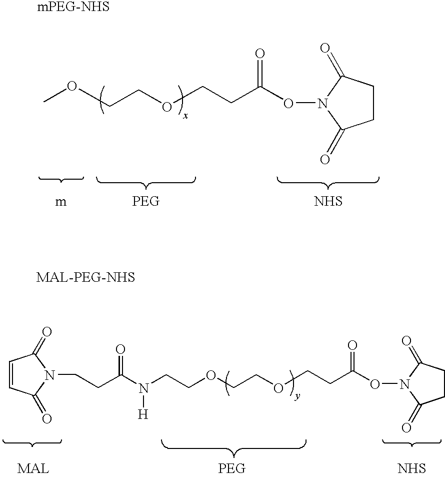

The value of “x” and “y” for the PEG moiety can comprise from about 6 to about 200 repeat units, for example, from about 20 to about 150 repeat units, or, for example, from about 80 to about 120 repeat units. In some aspects, a mixture of two poly(ethylene oxide) compounds with x and y values in two ranges, one having a lower range, for example, from about 6 to about 20 repeat units and the other at a higher range, for example, from about 100 to about 130 repeat units. One of skill in the art can determine the number of repeat units of the PEG moiety to achieve desired surface features.

Surface PEGylation can be implemented with a mono-, di-, or tri-alkoxysilane comprising a ω-methoxy-poly(ethylene oxide) or ω-methoxy-poly(ethylene glycol), i.e., mPEG.

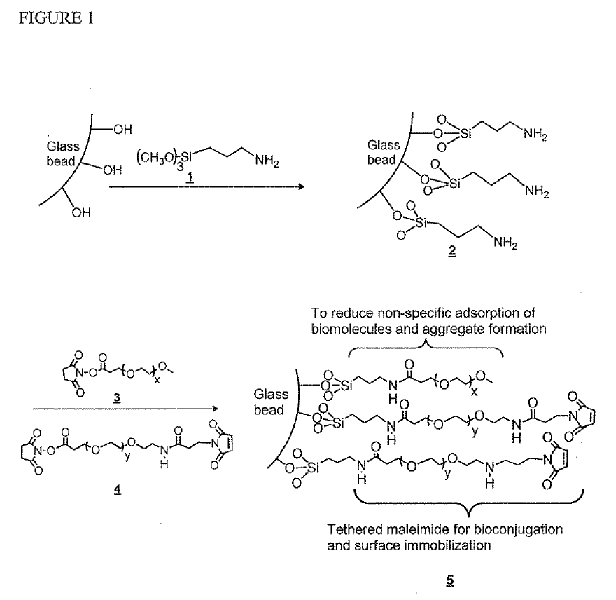

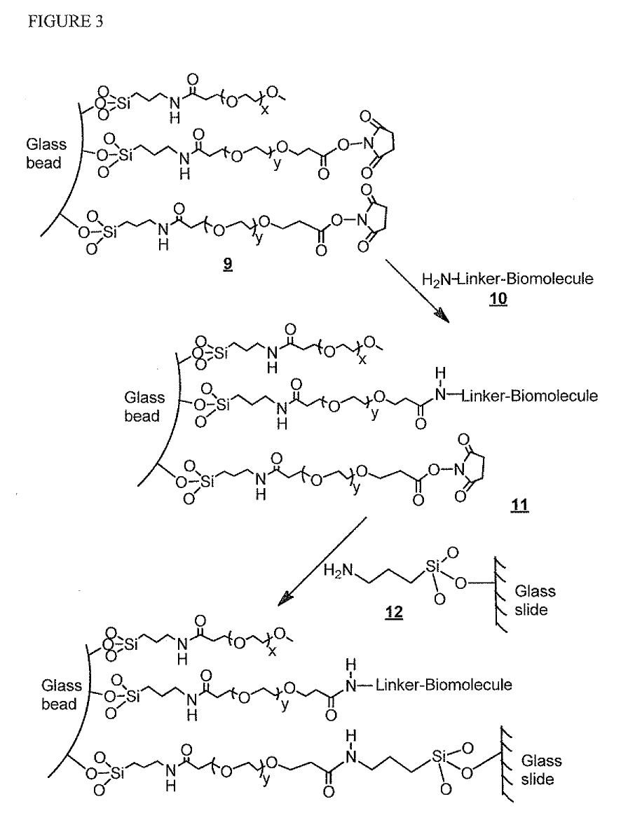

FIG. 1 illustrates a method to modify a particle surface or the surface of a substrate and immobilization of the particle to the substrate surface (FIG. 3). Following cleaning of the glass beads and increasing the surface density of silanol groups by soaking the beads in Piranha solution the beads are then silylated with 3-aminopropyltrimethoxysilane 1 (Gelest, Morrisville, Pa.) which introduces amino groups on the bead surface 2. Reacting the beads with a mixture of mPEG-NHS 3 (Quanta Biodesign, Powell, Ohio) and MAL-PEG-NHS 4 (Quanta Biodesign) provides a tethered maleimide 5 for bioconjugation and surface immobilization. The surface can be a glass, plastic or a surface containing mercapto or cyclopentadienyl groups. The reaction of 2 with 3 results in covering the bead surface with hydrophilic and fully hydrated polyethylene oxide) (PEG) to reduce non-specific adsorption of biomolecules. The presence of PEG can also sterically prevent the beads from clumping together to form aggregates. MAL-PEG-NHS 4 can anchor itself onto the bead surface by the reaction of its NHS-ester with a surface amino group.

One of skill in the art will recognize that other difunctionalized PEG molecules are available. Such molecules can be represented as

A-PEG-B

where the A and B moieties can be selected from the following structures, as would be known to one of skill in the art, depending on the desired surface properties and binding properties the modified surface:

| A | PEG | B | |
|---|---|---|---|
| 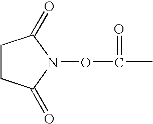 | 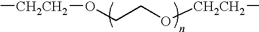 | 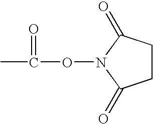 | (NHS) |
| 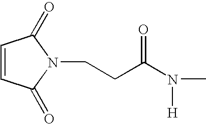 | | 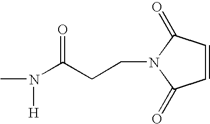 | (MAL) |
| 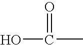 | | 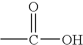 | (Carboxy) |
| HS— | | —SH | (Mercapto) |
| CH₃O— | | —OCH₃ | (m- or Methoxy) |
| H₂N— | | —NH₂ | (Amino) |
| 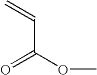 | | 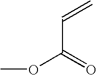 | (Acryloyloxy) |
| 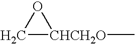 | | 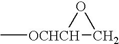 | (Epoxy) |
| 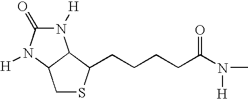 | | 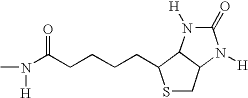 | (Biotin) |

The value of “n” for the PEG moiety can comprise from about 6 to about 200 repeat units, for example, from about 20 to about 150 repeat units, or, for example, from about 80 to about 120 repeat units. In some aspects, a mixture of two poly(ethylene oxide) compounds with n values in two ranges, one having a lower range, for example, from about 6 to about 20 repeat units and the other at a higher range, for example, from about 100 to about 130 repeat units.

FIG. 2 illustrates the surface bioconjugation of the tethered maleimide groups on the modified bead of FIG. 1 followed by chemical immobilization of the bead after a PCR reaction. Using a HS-Linker-Biomolecule to react with structure 5 of FIG. 1, an oligonucleotide biomolecule containing a mercapto group in its linker can be conjugated to 5 through the maleimide groups by Michael Addition Reaction (Exemplary embodiment 4A) to give 7. The oligonucleotide is tethered away from the bead surface to facilitate subsequence PCR/ligation reaction steps. Unreacted maleimide groups in 7 can be used to immobilize the bead onto cyclopentadiene-functionalized substrate surface 8 via a Diel-Alder Reaction, Exemplary embodiment 4B. The cyclopentadiene-functionalized substrate surface 8 can be prepared by silylation of a glass slide with 3-cyclopentadienylpropyltriethoxysilane (Gelest).

The tethered maleimide groups can be used for bioconjugation and/or immobilization of the bead onto the surface of a substrate as shown in FIG. 2. Such treatments include chemically bonding a poly(ethylene glycol) (PEG) moiety (a process hereinafter referred to a “PEGylating”) to surfaces, such as silicon, silicon dioxide and metal oxides, for example, but not limited to, indium-tin oxide and so on. One of skill in the art can immediately recognize that attaching molecules to the surface of the particle/bead to render the surface hydrophilic will provide reactive groups for subsequent bioconjugation and particle immobilization. Exemplary embodiment 3 provides a method for PEGylating the particle surface.

It is also possible to use a mixture of mPEG-NHS and NHS-PEG-NHS to chemically modify the glass bead surface to obtain 9 as shown in FIG. 3. Bioconjugation of the bead can be effected by amidation between the amino groups of the oligonucleotide 10 and the tethered NHS-ester to produce H. Immobilization of the glass bead relies on an amine-functionalized substrate surface 12 (Exemplary embodiment 2). The amine-functionalized substrate surface can be prepared using 3-aminopropyltrimethoxysilane 1 (Gelest) as shown in FIG. 1. The bead is immobilized to the substrate surface by the reaction of the amine groups protruding from the substrate with the tethered NHS-ester projecting from the bead surface. The method is further described in Exemplary embodiment 5A.

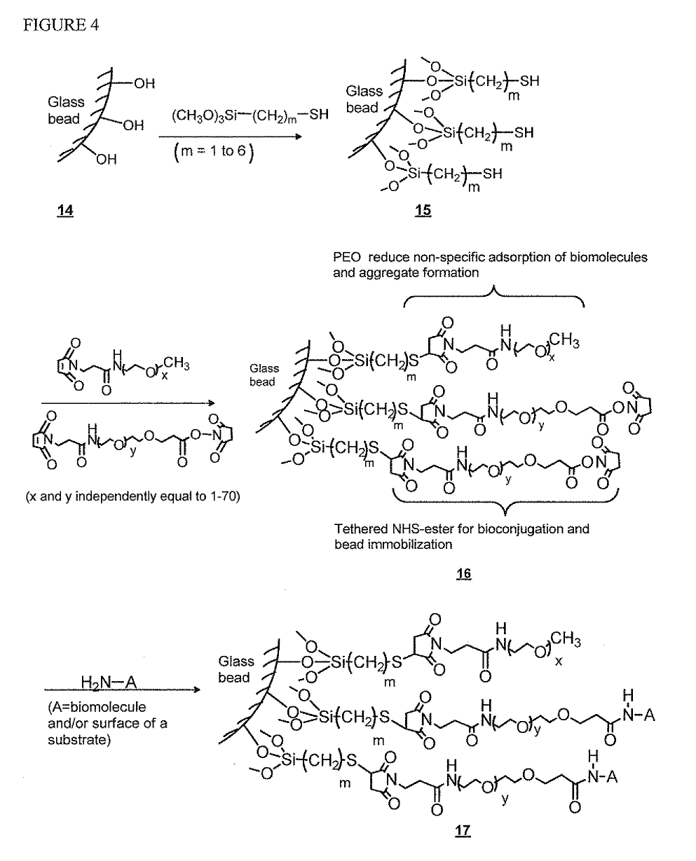

It is also possible to use a mixture of mPEG-MAL and MAL-PEG-NHS to PEGylate a thiolated glass bead surface 15 as shown in FIG. 4 and Exemplary embodiment 5B. The thiolated surface 15 is allowed to react through Michael Addition Reaction with a mixture of mPEG-MAL (Quanta Biodesign) and MAL-PEG-NHS (Quanta Biodesign) to give PEGylated surface 16 having NHS-ester groups for bioconjugation and immobilization 17. The thiol-functionalized bead surface can be prepared by reacting mercapto —(—CH₂—)ₘ trimethoxysilane (Gelest) (m=1 to 6) with beads pretreated according to Exemplary embodiment 1.

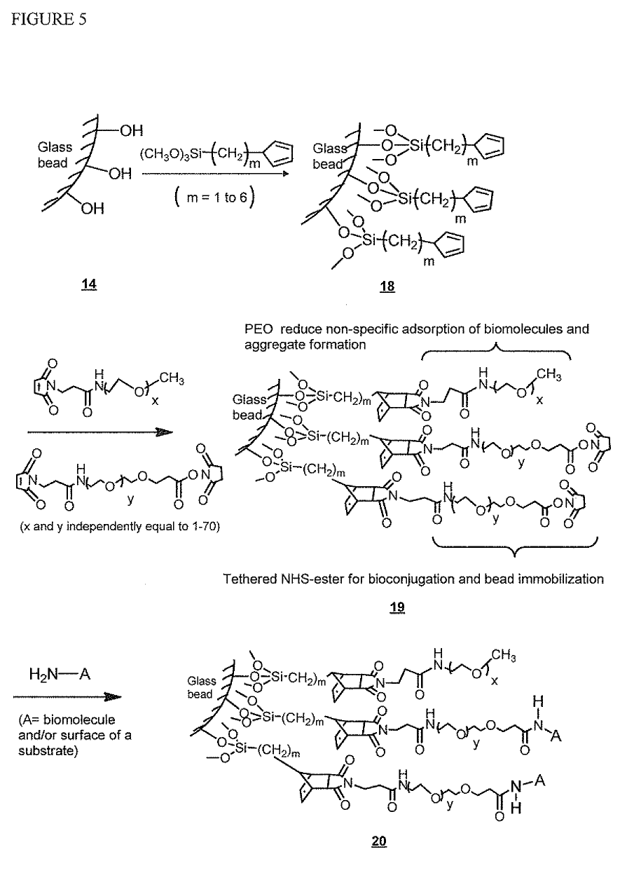

In another embodiment the pretreated glass particle from Exemplary embodiment 1 can be functionalized with cyclopentadienyl-(—CH2-)ₘ-trimethoxysilane (Gelest) (m=1 to 6) to give a surface 18 (FIG. 5). The cyclopentadiene-functionalized surface 18 is allowed to react through Diels-Alder Reaction with a mixture of mPEG-MAL (Quanta Biodesign) and MAL-PEG-NHS (Quanta Biodesign) to give PEGylated surface 19 comprising NHS-ester groups for bioconjugation and immobilization 20 as shown in Exemplary embodiment 5C. Those with skill in the art can appreciate that MAL-PEG-NHS can be replace with MAL-PEG-MAL. In this case the bioconjugation can be affected with a thiolated biomolecule and immobilization through a thiolated and/or cyclopentadienylated substrate surface.

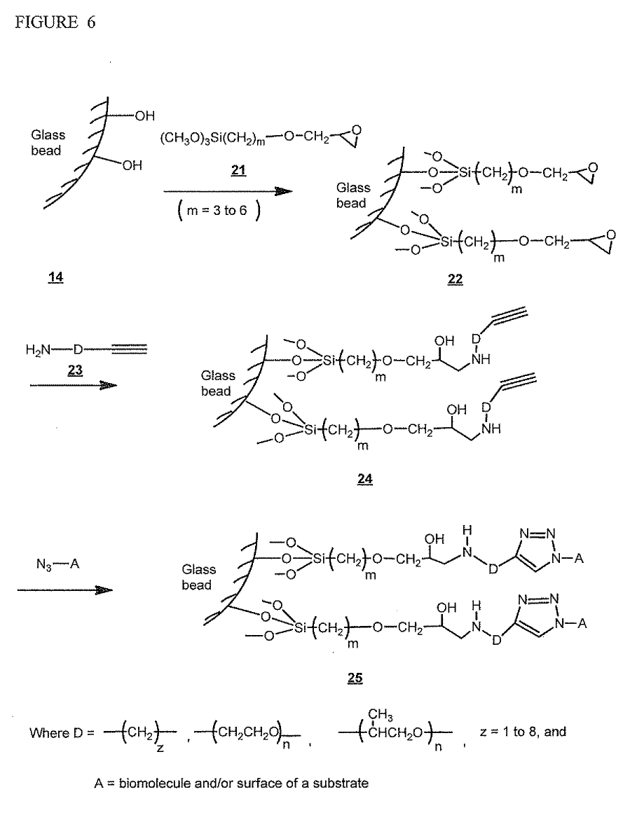

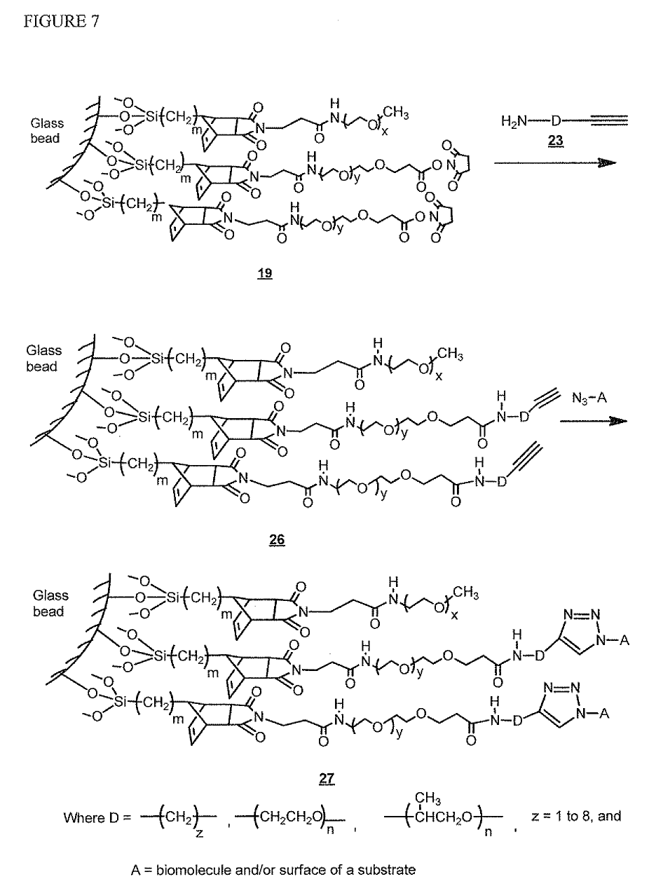

In various embodiments the preheated glass particle from Exemplary embodiment 1 can be reacted with an Epoxy-(—CH₂—)ₘ-trimethoxysilane 21 (m=1 to 6; 3-glycidoxypropyltrimethoxysilane when m=3, obtained from Gelest) resulting in the particle having an Epoxy-functionalized surface 22 (FIG. 6). The Epoxy-functionalized surface 22 is allowed to react through Click Chemistry, Approach I (H. C. Kolb and K. B. Sharples, 2003 DDT 8(24):1128-1136 and Baskin, J. M. et al., 2007 PNAS 104:16793-16797), incorporated herein by reference, with a H₂N-D—propargyl linker 23 to give a—propargyl surface 24. The propargyl surface 24 can react with N₃-A, where A is a biomolecule and/or surface of a substrate to render bioconjugation and immobilization 25 of the bead to the substrate surface as shown in Exemplary embodiment 6A.

Also envisioned is the use of a second Click Chemistry, Approach II (H. C. Kolb and K. B. Sharples, 2003 DDT 8(24):1128-1136 and Baskin, J. M. et al., 2007 PNAS 104:16793-16797). In Click II, the PEGylated surface 19 having NHS-ester groups is reacted with a H₂N-D-progargyl linker 23 to give propargylated surface 26. The propargylated surface 26 can react with N₃-A, where A is a biomolecule and/or surface of a substrate to render bioconjugation and immobilization 27 as shown in Exemplary embodiment 6B.

It will be appreciated that the use of so-called click chemistry (e.g. click reactions) may be used to provide a convenient mechanism by which to selectively direct the attachment of beads to a substrate surface. In various embodiments, at least one desirable characteristic that may result from incorporating a click chemistry based functional group is that beads may be seeded, deposited, or otherwise positioned on a substrate surface allowing for securing or immobilization of the bead to the substrate surface at a desired time. Such an approach may advantageously permit positioning and/or repositioning of the beads without attachment until a desired configuration is achieved. For example, in the context of positioning beads on a substrate surface to generate an ordered array or pattern of beads, the use of click chemistry may permit the beads to be aligned within given regions of the substrate, additional beads to be added to the substrate, allow beads to be removed from the substrate, or other such actions wherein the beads are able to be manipulated prior to securing to the substrate.

In various embodiments, when a desired bead configuration is achieved, a suitable chemical trigger or catalyst may be introduced to thereby secure the beads to the substrate surface. The chemical trigger or catalyst effectuates the immobilization of the population of beads in the desired configuration at a desired time. Such an approach may be advantageously applied in the context of generating an ordered array of beads and further aid in achieving higher packing densities of beads on the substrate surface in a controllable and selective manner.

Examples of mechanisms which may be adapted for use in selectively triggered/click chemistry approaches include, but are not limited to, copper-based catalytic reactions, thermally triggered reaction mechanisms, difluorinated cyclooctyne-based reactions, hydrophilic azacyclooctyne-based reactions, and azide-alkyne cycloaddition covalent modification approaches. Additional details regarding the application and chemical constituents of the aforementioned selectively triggered mechanisms that may be adapted for use with the present teachings are described by US Patent Publication 2009/0069738, A strain-promoted [3+2] azide-alkyne cycloaddition for covalent modification of biomolecules in living systems, J Am Chem Soc. 2004 Nov. 24; 126(46):15046-7; Dendronized linear polymers via “click chemistry”, J Am Chem Soc. 2004 Nov. 24; 126(46):15020-1; The growing impact of click chemistry on drug discovery, Drug Discov Today. 2003 Dec. 15; 8(24):1128-37; A hydrophilic azacyclooctyne for Cu-free click chemistry, Org Lett. 2008 Jul. 17; 10(14):3097-9. Epub 2008 Jun. 13; and Second-generation difluorinated cyclooclynes for copper-free click chemistry, J Am. Chem Soc. 2008 Aug. 27; 130(34):11486-93. Epub 2008 Aug. 5 the contents of each of which are hereby incorporated by reference in their entirety. It will further be appreciated that other suitable click chemistry or selectively triggered reaction approaches exist and are contemplated to be within the scope of the present teachings.

Exemplary embodiments 8, 9 and 10 provide methods to prepare the particle or the composite particle surface for chemical surface modifications by applying a layer of metal, for example, gold or other materials known to one of skill in the art. The metallic layer can also impart plasmon resonance properties to the particle as discussed below. Examples of metals include, but are not limited to gold, silver, palladium, platinum, aluminum, lead, iron, copper and alloys thereof, indium-tin oxide (ITO), coinage metals, noble metals, transition metals, diamond, carbon nanotube, synthetic metals, and alloys thereof and the like.

This exemplary list is not intended to be limiting and other metals known to one of skill in the art can also be used. The bare gold surface can be subjected to thiolation using o-mercapto-poly(ethylene oxide), for example mPEG-SH-5000 (Nektar, San Carlos, Calif.), rendering its surface hydrophilic (Exemplary embodiment 7). Those with ordinary skills in the art can appreciate other sulfur containing compounds, for example, but not limited to, disulfides and other oligomeric and polymeric compounds comprising thiol and/or disulfide groups can be used to render the gold surface hydrophilic.

Various reactions can be used to PEGylate a surface in accordance with the disclosure. One of skill in the art will appreciate that PEGylation can be achieved by many other reactions which, although not specifically discussed herein, are within the scope of the invention. The following reaction is an example of surface PEGylation on a silicon substrate using a trimethoxysilane having an mPEG moiety.

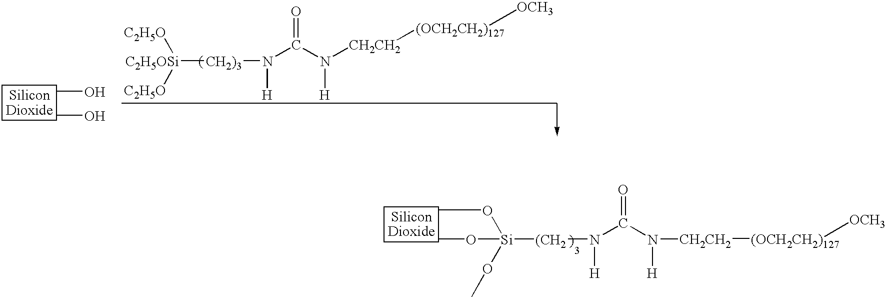

### Plasmon Resonance Surface Modifications

In certain embodiments of the present teachings are further directed to either creating a high energy field in a microstructure, i.e. sub-wavelength dimensions (or a high energy field) over a particle with a rough surface or attaching metallic particles (10 to 100 nanometers) to the surface of a nanoparticle (bead). One embodiment utilizes nanoparticles (at least 400 nanometers to at least 1 micron). It is known that solid metal nanoparticles (i.e., solid, single metal spheres of uniform composition and nanometer dimensions) possess unique optical properties. In particular, metal nanoparticles (especially the coinage metals) display a pronounced optical resonance. This so-called plasmon resonance is due to the collective coupling of the conduction electrons in the metal sphere to the incident electromagnetic field. This resonance can be dominated by absorption or scattering depending on the radius of the nanoparticle with respect to the wavelength of the incident electromagnetic radiation and physical surface characteristics of the nanoparticle (i.e., materials on the surface) and its size and shape. Associated with this plasmon resonance is a strong local field enhancement on the surface of the metal nanoparticle.

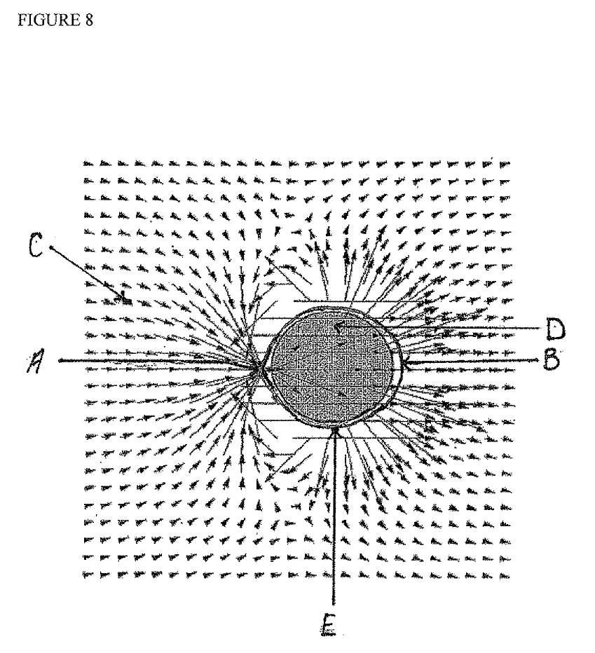

In some embodiments, an excitation light source may be directed at the nanoparticle. The excitation light source can be a laser, laser diode, a light-emitting diode (LED), an ultra-violet bulb, and/or a white light source. Plasmons are collective oscillations of free electrons at optical frequencies that travel across the metal surface of e.g., a nanorice particle. Plasmons on the surface of a nanoparticle are converted light energy. The plasmon's oscillation creates a resonance. The length of the metallic surface determines the wavelength of the plasmonic resonance which directly correlates to the incoming light's wavelength. The wavelength of the electron associated with the metallic surface is shorter than the wavelength of the photon (which generates the plasmon) even thought they are at the same frequency. This resonant effect can create high intensity local electrical fields that radiate around the particle as diagramed in FIG. 8. The shape of the particle influences the strength of the energy field created by plasmon resonance with the ends of a nanorice-shaped particle having stronger fields than fields measured for spherical and rod-shaped particles. Additionally, in various embodiments, the nanoparticle surface can be coated with a layer of small beads. Variation in either the size or materials of the small beads can be selected by one of skill in the art such that a greater set of wavelengths can be covered to elicit the desired resonant effect. Nanorice-shaped particles are illustrative of the surface, shape and size issues for plasmon resonance.

The nanoparticle core can also be surrounded by a shell. The shell can be a metallic material or a dielectric. The thickness of the metallic shell, length of the nanoparticle, e.g., nanorice, and width of the core can be manipulated to generate a specific frequency of plasmon resonance. A method of fabrication for nanorice is described in Nanorice: A Hybrid Plasmonic Nanostructure, Nano Lett., 6(4), 827-837, 2006 Hui Wang et al., which is incorporated by reference in its entirety.

Accordingly, excitation light can be directed at the particle to generate plasmons in a small volume of space extending beyond the surface of the nanoparticle. This method of generating plasmons has a side benefit that bleaching does not occur as quickly as in conventional methodologies. The proximity of the fluorophore to the metal surface of the nanoparticle causes the fluorescence lifetime of the fluorophore to decrease which can increase the fluorescence photon emission rate and the total number of emitted photons before bleaching. Thus, sensitivity of the fluor and its detection is increased. Additionally, there can be a further improvement in the signal to background noise ratio.

In other embodiments, other nanostructucture shapes can be used. For example, nanorice, nanorods, nanorings, nanocubes and nanoshells can be used, depending on the user-requirement. Each of the nanostructures exhibit their own resonant wavelength, intensity of field, number of fields generated and the like.

In accordance with various embodiments, excitation light can be directed at the particle surface at an approximately 90 degree angle or in an angular direction where surface plasmons can couple with the excitation light and create a resonant field. In essence the surface of the particle can be functioning as a resonance structure, which then can be applied to applications such as single-molecule sequencing, ligation sequencing, hybridization, or other applications, including diagnostic applications, directed at detecting small particles with a reduced background clutter as compared to conventional systems. Moreover, the angle of the excitation light, the particle size and shape or thickness of the metallic surface will affect the number of plasmons being generated as well as efficiency and location of the plasmons.

The plasmons can also exhibit areas of high field strength termed focusing. As shown in FIG. 8, the photons generate plasmons in a “focused” area of strength A at one point on the particle's surface along with an increased concentration of plasmons at a second focal point, B. The incident light C absorbed by a particle with a metallic surface D creates the resonant field E. The plasmons in the resonance field surrounding the particle can be reused multiple times as the plasmons traverse the particle surface multiple times and simultaneously the focused areas A and B exhibit greater plasmon density in a small area. Consequently, the plasmon resonance provides an opportunity for the excitation energy to have multiple opportunities to interact with a fluorophore in close proximity to the nanoparticle.

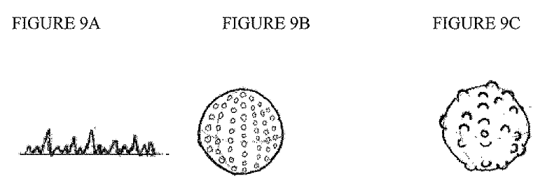

As send in FIG. 9A, a metallic particle with a rough surface allows resonance of the plasmons on a larger particle on the rough surface irregularities and provide further focused resonance opportunities for the plasmons or higher fluctuations in a small area. By varying the metallic material on the surface and/or the texture of the surface of the particle one of skill in the art can determine the wavelength range in conjunction with the desired resonant effect. The wavelength range could be broad (400 nm to 800 rim) or narrow (a breadth of about 20 nm to 30 nm). Methods for the deposition of the metal on the particle surface can be by evaporation, vapor deposition, sputtering, or by first attaching a linker to which the metal can bind as is known to one of skill in the art.

The particle can also be a composite structure coated with a layer of a metallic material including, but not limited to, a metal, for example but not limited to, stainless steel or another metal alloy, coinage metals, noble metals, transition metals, aluminum, diamond, carbon nanotube, and synthetic metals, and alloys thereof, and indium-tin oxide (ITO), and metal oxides. The composite particle coated with the metallic material can impart plasmon resonance properties to the composite particle. Naturally, a non-magnetic metal would coat the composite structure when magnetic, paramagnetic or super paramagnetic particles are trapped, embedded, attached and/or adhered in/onto the composite particle. A particle with either a continuous or a discontinuous composite coating is illustrated in FIG. 9B and 9C, respectively.

The core of the particle can be made of a solid or a composite of materials selected from the materials which make up a particle including but not limited to silica, dielectric materials, other metals and their alloys and magnetic, paramagnetic, and super paramagnetic materials. The core can be at least 1 nanometer to 1 micron in diameter, amorphous or crystalline.

In some embodiments, the core, particle or composite structure can also be configured to systems and methods, which use surface plasmons. The surface plasmons are located at the surface or formed between adjacent particles of a resonant structure. When light is absorbed by the structure's metal surface, a plasmon resonance is created depending on the physical shape of the structure, the wavelength of the light focused on the particle's surface and the composition of the surface (e.g., dielectric(s) and metal(s)). The plasmon resonance conditions are influenced by the material(s) surrounding, applied to, coating, sticking or adhering to the particle surface, size of the particle and particle composition, including the metal(s) and dielectric(s). The wavelength of the light effects plasmon formation and can be varied from the oscillation period of the plasmon, up to two times the oscillation period of the plasmon and up to ten times the oscillation period of the plasmon. That range and any ranges discussed in this application include the endpoints and all values between the endpoints. Metallic particles or metallic coated cores which form a particle as described above can be described as nanorice, nanocresents, nanostars, nanorods, nanorings, nanocubes and nanoshells. These “nano”particles can be varied in size and aspect which allows the nanoparticles to be tuned to vary the absorption spectra of the nanoparticle and the energy of the generated plasmon. The embodiments that create a localized plasmon resonance, may then be used in applications such as single-molecule detection and fluorescent correlation spectroscopy (“FCS”). Other applications include single molecule sequencing, ligation sequencing (U.S. Ser. No. 11/345.979 by McKernan et al. filed Feb. 1, 2006) and multiple molecule sequencing (U.S. Ser. No. 11/476,423 by D. R. Smith and K. F. McKernan filed Jun. 28, 2006), each incorporated herein by reference.

In another embodiment, the appropriate particle size, thickness and material surrounding the particle is such that plasmon resonance is generated on the peripheral surface thus, enhancing the energy available as well as placing it in a small volume. An excitation light is directed to the surface of the particle. In various embodiments, the particle can have a coating. A thin coating, 5 to 20 nm, can be configured to stand off a fluorophore to prevent quenching of the fluorophore by the metal. Examples of coatings include but are not limited to silane tetrahydrothiophene(AuCl) with a silica core coated with diphenyltriethoxy silane leaves a surface terminated with gold chloride ions which can provide sites for additional gold reduction. In other embodiments, a thin shell of another nonmetallic material, such as cadmium sulfide or cadmium selenide grown on the exterior of a silica particle allows for a metallic shell to be reduced directly onto the nanoparticle's surface. In other embodiments, functionalized oligomers of conducting polymers can be attached in solution to the functionalized or nonfunctionalized surface of the core nanoparticle and subsequently cross-linked by thermal or photo-induced chemical methods. Exemplary embodiment 8 provides a method for attachment of Linker molecules for use in attaching a metallic material to a nanoparticle as well as exemplary coatings.

The particle or the coating on the particle can also have metal clusters attached to the core or the particle's surface via linker molecules. Any metal that can be made into a colloidal form could be attached as a metal cluster. Exemplary embodiment 9 provides a method for attaching metal clusters to particles. The metal clusters can also be enlarged by the deposition of gold to surround the particle with a metallic shell as described in Exemplary embodiment 10.

For all the disclosed embodiments, a biomolecule, a target DNA, a primer, an oligonucleotide or an enzyme can be attached to the particle surface, including in the area of highest energy intensity. One method of creating this attachment can utilize a photo-activated attachment such as photo-activated biotin. At low intensity light levels, the molecules would be preferentially attached at the point of highest energy on the structure. The excitation or emission could use the disclosed methods either individually or in combination with other conventional methodologies such as far field microscopy, total internal reflection fluorescence (TIRF), microscopy plasmon resonance or other methods of coupling to provide energy to the structures. Use of TIRF or plasmon resonance minimizes the excitation to a very thin layer reducing unwanted background. The depth of penetration of the evanescent wave resulting from TIRF excitation is a function of the angle of incidence, where the penetration is greatest at the critical angle, and diminishes as the angle between the substrate and the excitation light decreases. Thus, to minimize the depth of penetration, and thus the volume of solution that is excited by the evanescent wave, it is preferable to minimize the angle. For example, this can be accomplished by using a high NA TIRF objective and utilizing a laser brought in at the extreme edge of the objective.

The surface modified nanoparticles can be used for single molecule fluorescence. The surface modified particles can be used to create two-photon emission from dyes using the wavelength of the antenna/nanoparticle instead of the excitation wavelength. Two-photon emission requires two photons to excite a molecule prior to the emission of a photon. With two-photon emission, the generated fluorescence is at a wavelength lower than the excitation, permitting easy filtering of background fluorescence of the substrate, optical elements and other nonspecific fluorescence. Furthermore, the probability that two-photon emission will occur is a function of the excitation power squared, thus, for example, if a device has an optical enhancement of 100, a fluorophore in a resonant enhancement zone is actually 10,000 times more likely to be excited than a fluorophore which is not in a resonant enhancement zone, greatly reducing background from nearby fluorophores. As such, they could be used for nucleic acid sequencing, sequencing by ligation, single molecule-detection methods and also for many other types of applications, including diagnostics, where it is desired that small volumes be excited.

The methods and compositions as disclosed herein, however, are not restricted to any particular bioconjugation system. The surface modifications as disclosed herein can be used in any bioconjugation system which uses covalent or ionic bonds and relies on functionalized groups to react with other functionalized groups to tether two moieties together. See for example, G. T. Hermanson, “Bioconjugate Techniques,” 2^{nd} Edition, Academic Press, San Diego, Calif. (2008) and C. M. Niemeyer, “Bioconjugation Protocols-Strategies and Methods,” Human Press, Totowa, N.J. (2004). All of the above references are incorporated herein by reference. This invention is not limited to any particular amplification system. As other systems are developed, those systems may benefit by practice of this invention. A recent survey of amplification systems was published in Abramson and Myers, 1993, Current Opinion in Biotechnology 4:41-47, incorporated herein by reference for all purposes.

Preparation and synthesis of particles are described in the art (see, for example, U.S. Pat. Nos. 7,144,627, 6,344,272 and 6,699,724 and U.S. patent application Ser. Nos. 09/965305 and 09/066544. Methods for applying a metallic shell on a bead and metal alloy shells on beads are described in Steinbruck et al., 2006, Plasmonics 1:79-85; P. Mulvaney, 1996, Langmuir 12:788-800; and S. Link and M. A. El-Sayed, 2003, Annu. Rev. Phys. Chem. 54:331-66. The effect of surface roughness on plasmon resonance is described in S. Negm and H. Talaat, 1992, Ultasonics Symposium pp. 509-514. The size of the particle and the effect of size on absorbance by gold particles is described in Berciaud, et al. 2005, Nano letters 5(3):515-518 and S. A. Maier and H. A. Atwater, 2005, J. App. Phys. 98, 011101-1-10. Particle shapes and the effect on plasmon resonance is described in Lu et al., 2005, Nano Letters 5(1):119-124, and Nehl et al., 2006, Nano Letters 6(4):683-688.

Coating the surface of the particle with a dielectric coating is described in Farrer et al., 2005, Nano Letters 5(6):1139-1142, Liz-Marzan et al., 1996, Langmuir 12:4329 and G. Schneider and G. Decher, 2006, Nano Letters 6(3):530-536. Wang et al., 2006, Nano Letters 6(4):827-832, The effect of surface structure on hydrophobicity is described in Martines et al., 2006, Nano Letters 5(10):2097-2103. The effects of distance between particles, particle size and fluorescence are described in Reinhard et al., 2005, Nano Letters 5(11):2246-2252, Malicka et al., 2003, Anal. Biochem. 315:57-66 and Chen et al., 2007, Nano Letters 7(3):690-696. The coupling of silver particles can also effect the signal level from a single molecule attached to a metal particle and is described in Zhang et al., 2007, Nano Letters 7(7); 2101-2107.

Oxidation of a particle surface is described in the art. See for example, Cao et al. 2006, Anal. Chem. 351:193-200 and N. Dougami and T. Takada, 2003, Sensors and Actuators B 93:316-320.

Thus, the compositions and methods as disclosed herein are useful because they reduce magnetism hysteresis, clumping together of beads and aggregate formation of beads. The tethering away of NHS ester or maleimide functional groups from the bead surface will favor the kinetics of polymerase chain reactions (PCR) and ligation reactions, facilitate immobilization of beads to a surface such as a silylated glass or other substrate and surprisingly, due to plasmon enhancement, the bead can generate more/enhance fluorescent signal and provide for easier covalent attachment chemistries for biomolecule attachment and particle immobilization.

The surface modifications and methods of modifying particle surfaces as described herein can be used in a variety of potential applications, including nucleic acid sequencing, sequencing by ligation, single molecule-detection methods and other uses which can be applicable in diagnostic applications. These techniques can be utilized in any application where a diverse collection of DNA or RNA fragments, as cDNA, are amplified or modified in isolation from each other using a set of amplification or modification reagents.

Aspects of the present teachings may be further understood in light of the following exemplary embodiments, which should not be construed as limiting the scope of the present teachings in any way.

### Exemplary Embodiments

Those having ordinary skill in the art will understand that many modifications, alternatives, and equivalents are possible. All such modifications, alternatives, and equivalents are intended to be encompassed herein.

The following procedures are representative of procedures that can be employed for the chemical modifications of particle surfaces and the surface of the substrates to which the particles are immobilized for use in PCR, sequencing ligation methods and single molecule-detection methods. As set forth above, the modification of the particle/bead surface can facilitate bioconjugation for PCR/ligation sequencing reactions, reducing bead aggregation and enhancing detection of sequencing products.

The following procedures are representative of procedures that can be employed for the surface modification of glass, silica, quartz, silicon particles and metallic surfaces although the procedures are readily adaptable to other materials and compositions as would be known to one of skill in the art.

### Exemplary Embodiment 1

### Procedure for Pre-Treatment Prior To Surface Chemical Modification

The glass beads can be cleaned and dry according to procedures known to the skilled artisan and then treated with Piranha solution to increase the surface density of silanol groups. Porous glass or a silicon bead/particle can be sonicated in 30 ml of 1.0% sodium dodecylsulfate (SDS) for 20-60 minutes. The particle can then be thoroughly rinsed with deionized water. The particle can be subsequently sonicated in a mixture of 5 mL of 29% NH₄OH, 5 ml of 30% H₂O₂, and 20 mL of DI water for 20-60 minutes. It can then be rinsed with DI water thoroughly. The bead/particle can then be sonicated in a mixture of 5 mL of 38% HCl, 5 mL of 30% H₂O₂, and 20 mL of DI water for 20-60 minutes and rinsed with DI water thoroughly. The particle can then be air-dried and used immediately.

### Exemplary Embodiment 2

### Procedure for Surface Chemical Modification Using Aminosilane Reagents

Into 35 ml of 100% EtOH, 1.0 mL of aminopropyl trimethoxysilane 1 (Gelest) can be added and stirred to dissolve. The pre-treated bead/particle from Exemplary embodiment 1 can then be soaked in this silane solution for 30 minutes while agitated (e.g., with an orbit shaker). The particle can then be removed and dipped into 100% ethanol briefly and excess solvent is shaken off. The particle can then be cured at 110° C. for 20 minutes to give an aminated surface 2.

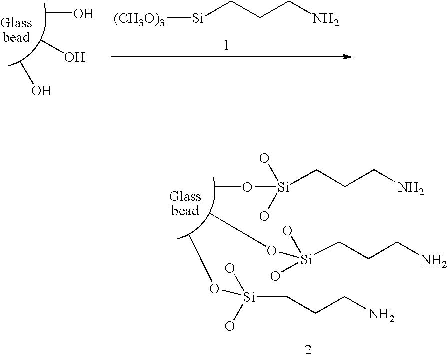

### Exemplary Embodiment 3

General Procedure for Solution PEGylation to Render a Surface of a Glass or Silicon Bead Hydrophilic and Functionalized for Bioconjugation

The aminated surface 2 is allowed to react with a mixture of mPEG-NHS 3 (Quanta Biodesign) and MAL-PEG-NHS 4 (Quanta Biodesign) in tetrahydrofuran (THF) to give PEGylated surface 5 comprising maleimide groups for bioconjugation and immobilization.

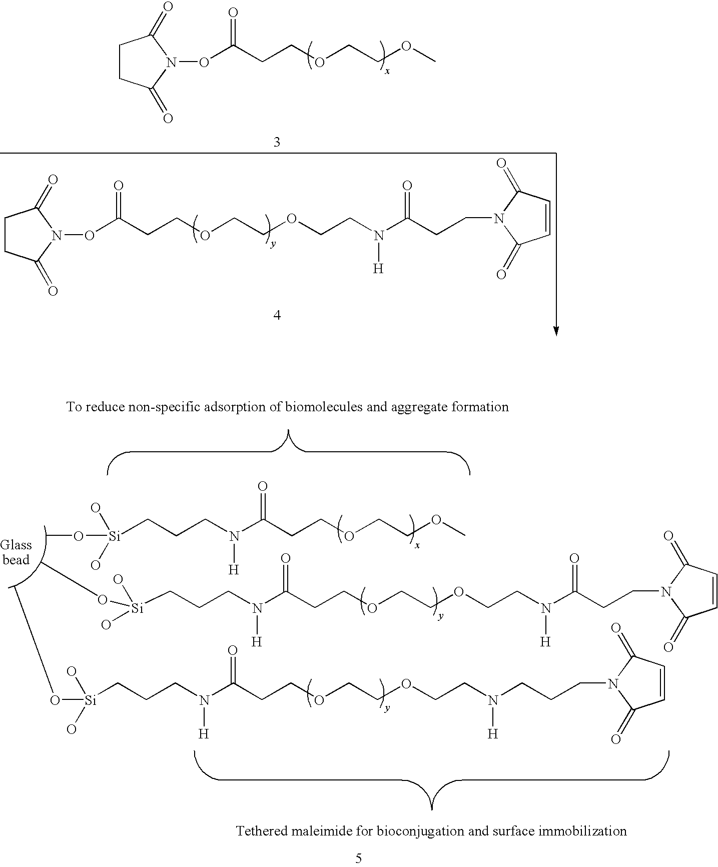

The value of “x” and “y” for the PEG moiety can comprise from about 6 to about 200 repeat units, for example, from about 20 to about 150 repeat units, or, for example, from about 80 to about 120 repeat units. In some aspects, a mixture of two poly(ethylene oxide) compounds with x and y values in two ranges, one having a lower range, for example, from about 6 to about 20 repeat units and the other at a higher range, for example, from about 100 to about 130 repeat units. One of skill in the art can determine the number of repeat units of the PEG moiety to achieve desired surface features.

### Exemplary Embodiment 4A

Procedure for Attachment of a Biomolecule to a Surface Modified Particle by Michael Addition Reaction

Attachment of biomolecules can be effected by reacting the tethered maleimide group 5 of the PEGylated beads suspended in an aqueous medium with HS-Linker-Biomolecules 6 (for example, oligonucleotides containing thiol groups) through Michael Addition Reaction to give 7. The oligonucleotide is tethered away from the bead surface to facilitate subsequent PCR, immobilization and ligation reaction steps.

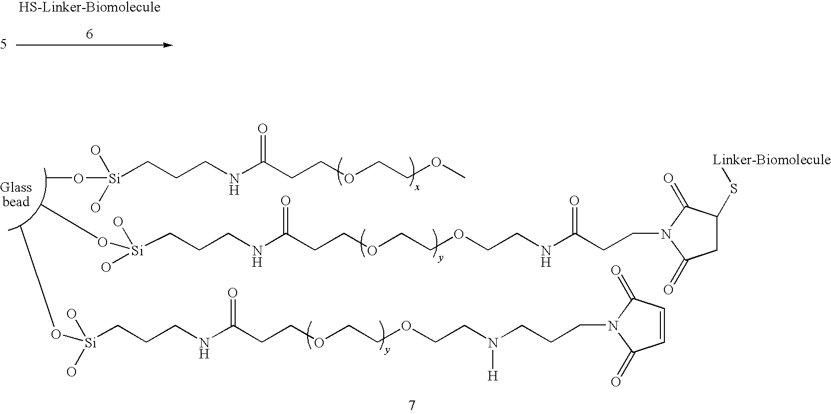

The values of x and y are as described above.

### Exemplary Embodiment 4B

### Protocol for Immobilization by Diels-Alder Reaction

Unreacted maleimide groups in 7 can be used to immobilize the bead onto a cyclopentadiene-functionalized substrate surface 8 via a Diels-Alder Reaction. The cyclopentadiene-functionalized substrate surface 8 can be prepared by silylation of a glass slide with 3-cyclopentadienylpropyltriethoxysilane (Gelest).

The values of x and y are as described above.

### Exemplary Embodiment 5A

### Protocol for Bioconjugation and Immobilization Using the Ester of N-hydroxysuccinimide

It is also possible to use a mixture of mPEG-NHS and NHS-PEG-NHS to chemically modify the aminated glass bead surface 2 (Exemplary embodiment 2) to obtain 9. Bioconjugation of the bead can be affected by amidation between the amino groups of the oligonucleotide 10 and the tethered NHS-ester to produce H. Immobilization of the glass bead relies on an amine-functionalized substrate surface 12. The amine-functionalized substrate surface can be prepared using 3-aminopropyltrimthoxysilane (Gelest) as shown in Exemplary embodiment 2.

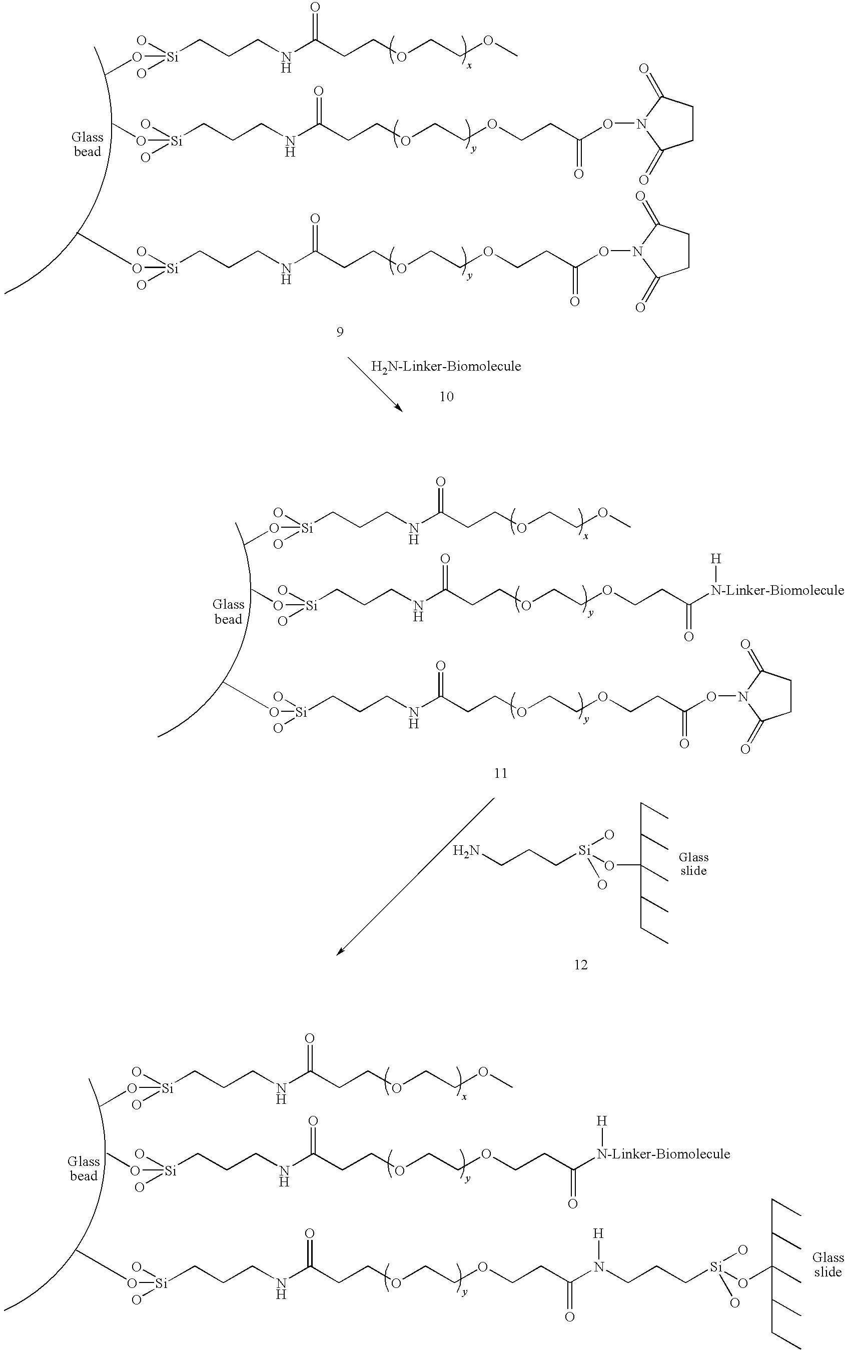

The values of x and y are as described above.

### Exemplary Embodiment 5B

### PEGylation, Bioconjugation and Immobilization Based on Michael Addition Reaction

The surface of the glass particle from Exemplary embodiment 1 is soaked in a solution of mercapto —(—CH₂—)ₘ, trimethoxysilane (Gelest) (m=1 to 6) dissolved in 100% EtOH for 30-45 minutes with agitation. The particle can then be removed and dipped into 100% ethanol briefly and excess solvent is shaken off. The particle can then be cured at 110° C. for 20 minutes to give a thiolated surface 15. The thiolated surface 15 is allowed to react through Michael Addition Reaction with a mixture of mPEG-MAL (Quanta Biodesign) and MAL-PEG-NHS (Quanta Biodesign) to give PEGylated surface 16 comprising NHS-ester groups for bioconjugation and immobilization 17.

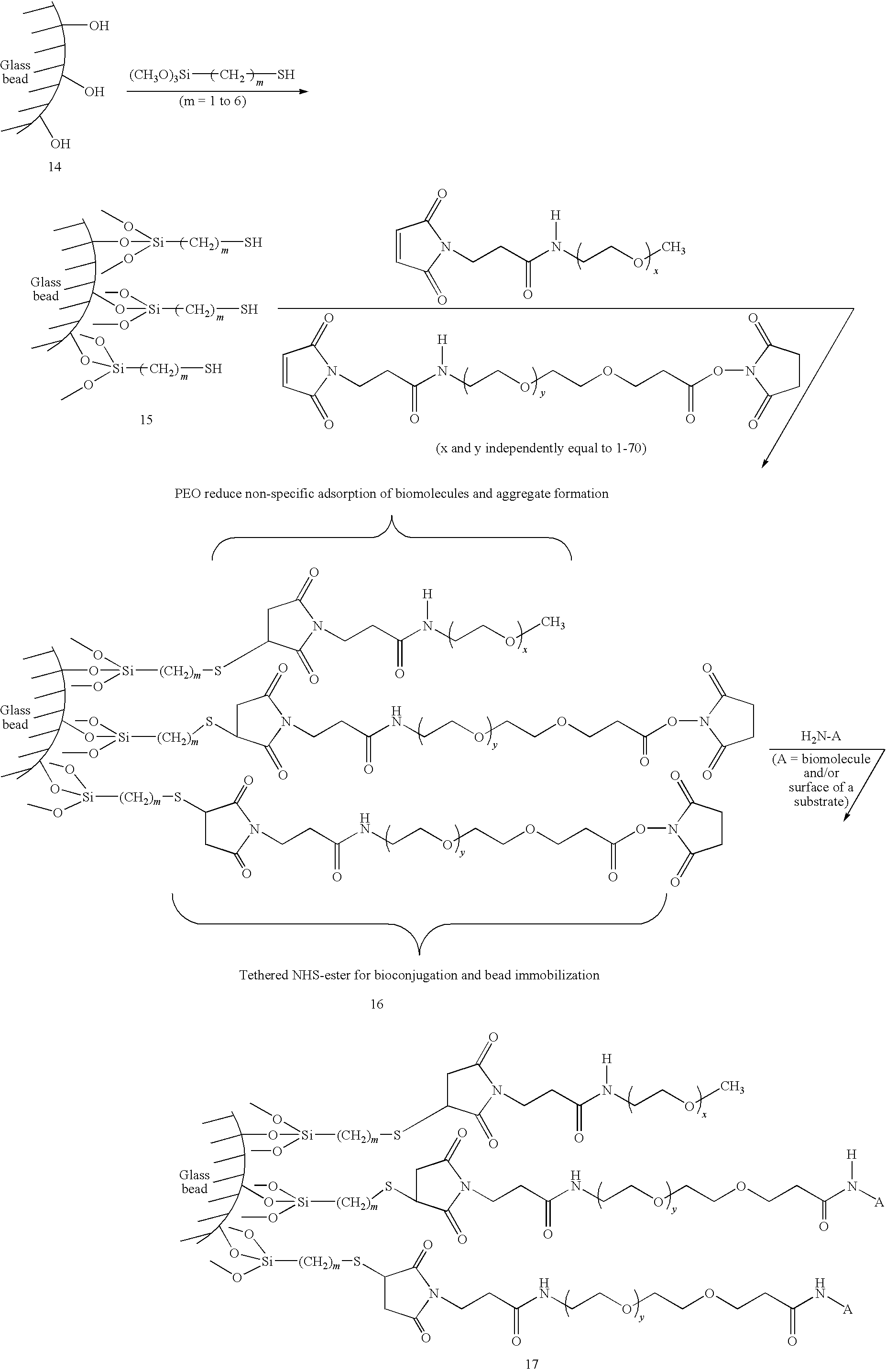

The values of x and y are as described above.

### Exemplary Embodiment 5C

PEGylation, Bioconjugation and Immobilization Based on Diels Alder Reaction

The glass particle from Exemplary embodiment 1, 14 is soaked in a solution of ω-cyclopentadienyl —(CH₂)ₘ trimethoxysilane (Gelest) (m=1 to 6) dissolved in 100% EtOH for 30-45 minutes with agitation. The particle can then be removed and dipped into 100% ethanol briefly and excess solvent is shaken off. The particle can then be cured at 110° C. for 20 minutes to give a cyclopentadiene-functionalized surface 18. The cyclopentadiene-functionalized surface 18 is allowed to react through Diels-Alder Reaction with a mixture of mPEG-MAL (Quanta Biodesign) and. MAL-PEG-NHS (Quanta Biodesign) to give PEGylated surface 19 comprising NHS-ester groups for bioconjugation and immobilization 20.

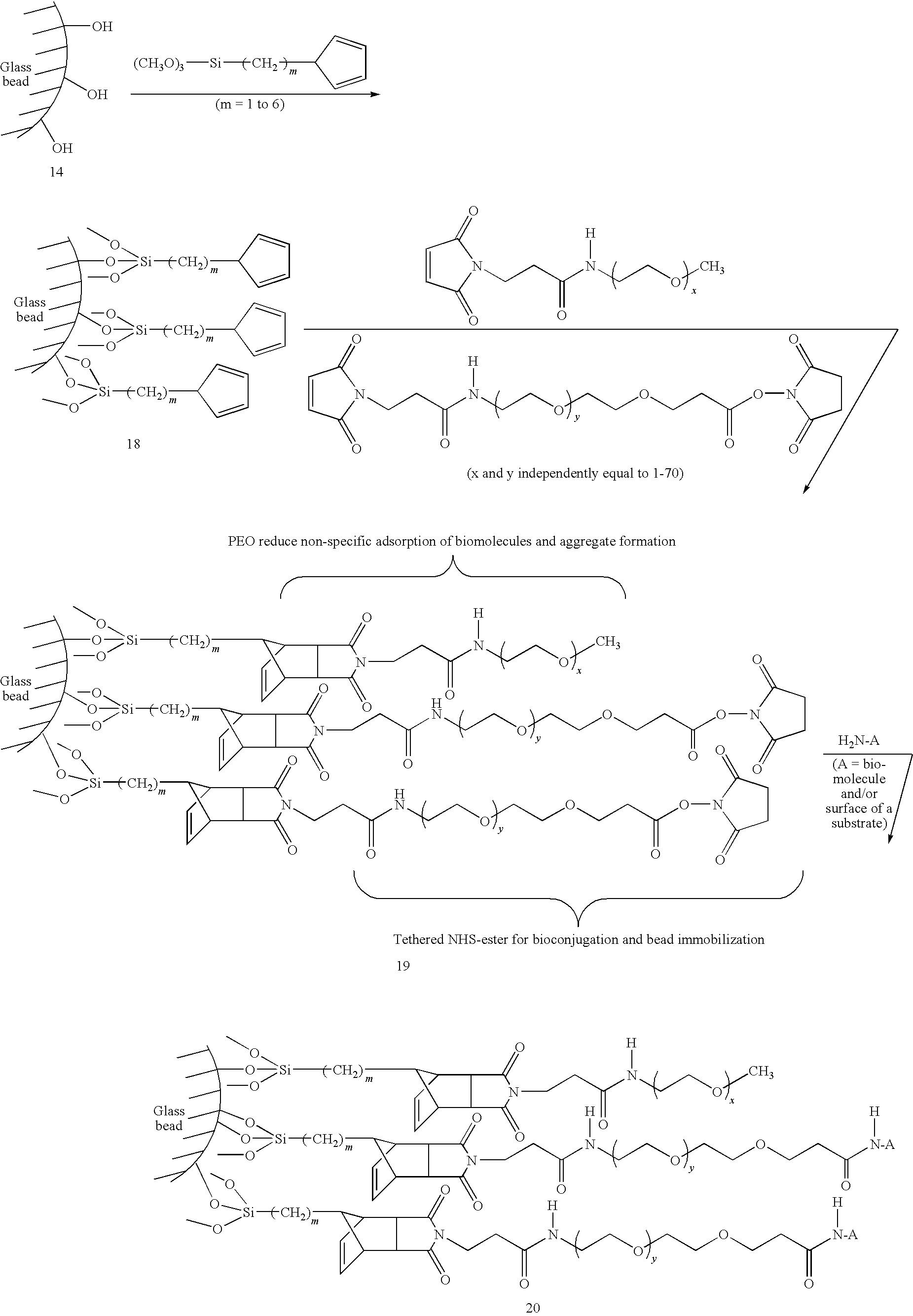

The values for x and y are as described above.

### Exemplary Embodiment 6A

Protocol using Click Chemistry Approach I:

The pretreated glass particle from Exemplary embodiment 1, 14 is soaked in a solution of (3-glycidoxypropyltrimethoxysilane, when m=3), 21 (Gelest) dissolved in 100% EtOH for 30-45 minutes with agitation. The particle can then be removed and dipped into 100% ethanol briefly and excess solvent is shaken off. The particle can then be cured at 110° C. for 20 minutes to give an epoxy-functionalized surface 22. The epoxy-functionalized surface 22 is allowed to react through Click Chemistry Approach 1 with a H₂N-D-propargyl linker 23 where D is —(—CH2-)_{z}-, —(—CH2CH2O—)ₙ— or —(—CH(CH₃)CH₂O—)ₙ—, z=1 to 8 and n=1 to 200, to give surface 24 having a propargyl moiety to react with N₃-A, where A is a biomolecule and/or surface of a substrate for bioconjugation and immobilization 25.

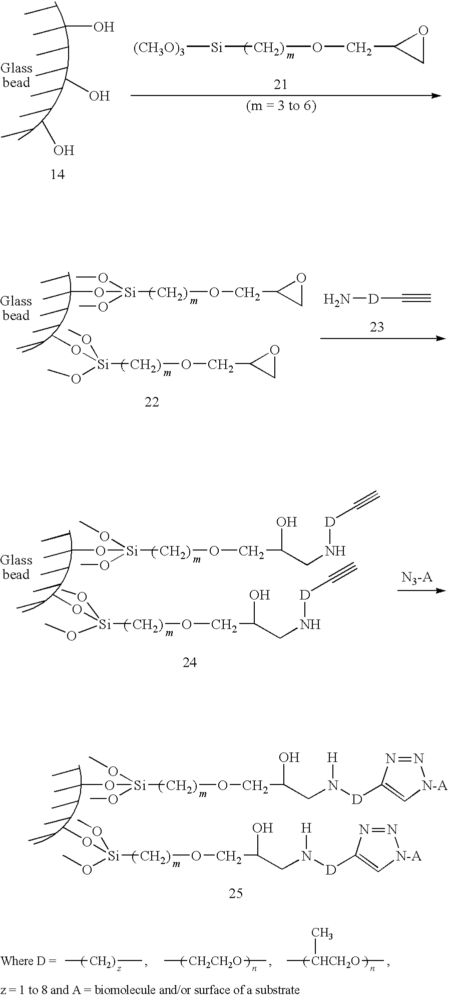

The values of x and y are as described above.

### Exemplary Embodiment 6B

Protocol using Click Chemistry Approach II:

The PEGylated surface 19 having NHS-ester groups is reacted through Click Chemistry Approach II with a H₂N-D-propargyl linker 23 where D is —(—CH₂—)_{z}—, —(—CH₂CH₂O—)ₙ— or —(—CH(CH₃)CH₂O—)ₙ—, z=1 to 8 and n=1 to 200 to give surface 26 having propargyl linkers to react with N₃-A, where A is a biomolecule and/or surface of a substrate for bioconjugation and immobilization 27.

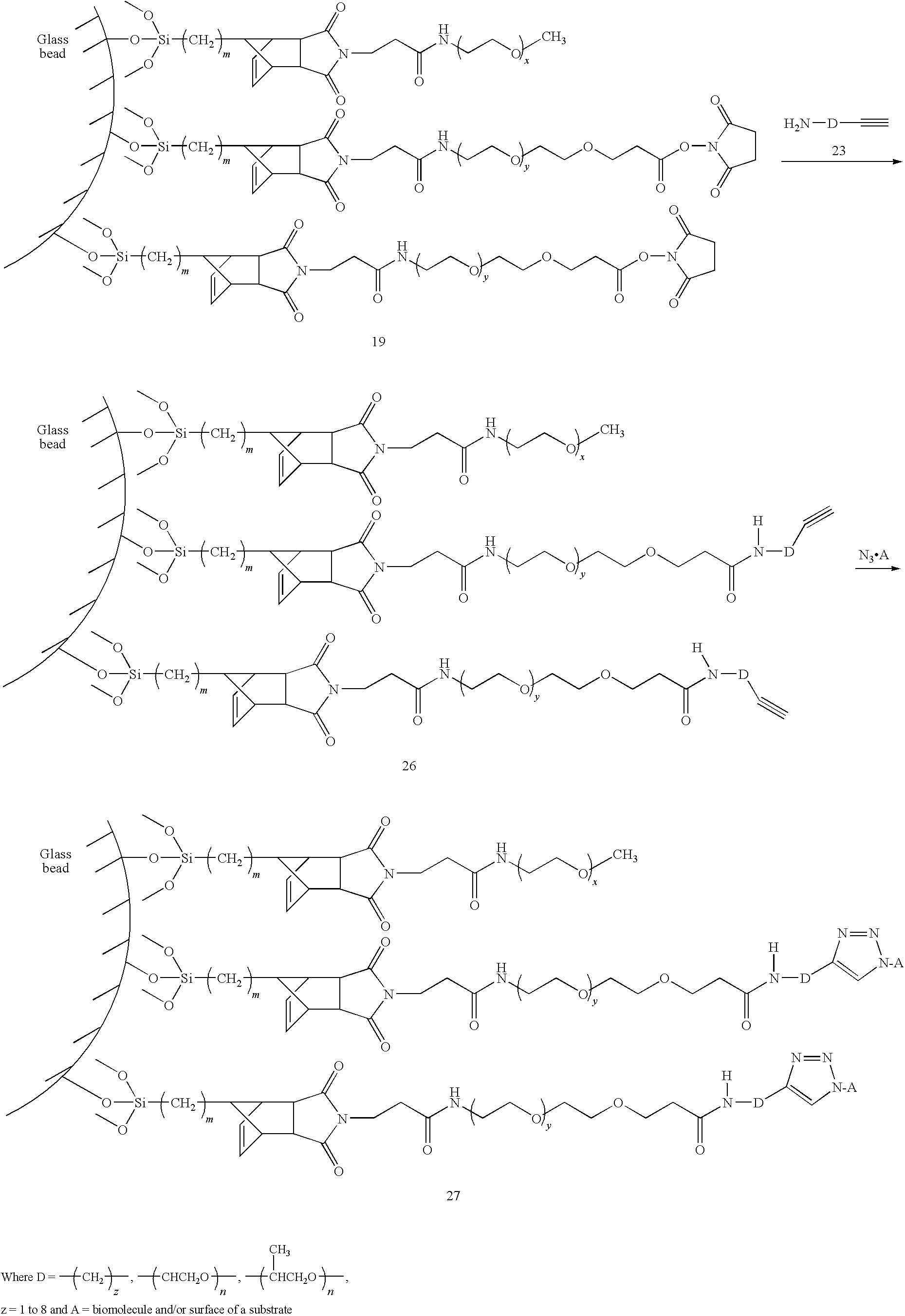

The values for x, y and m are as presented above.

### Exemplary Embodiment 7

### General Procedure to Render a Gold Surface Hydrophilic

A gold surface can be subjected to a PEGylation process to render the gold surface hydrophilic. The gold surface is exposed to an aqueous tetrahydrofuran (THF) solution containing a mercapto-functionalized poly(ethylene glycol) (molecular weight 5,723 Da, Nektar). The mercapto groups form a strong covalent bond with the gold layer via the sulfur (S) bond. The resulting gold surface layer-has poly(ethylene glycol) groups (PEG) bonded to the gold.

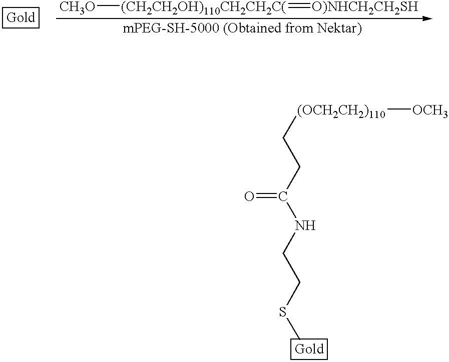

### Exemplary Embodiment 8

### Linker Molecule Attachment

To assemble a metallic shell around an inner layer, frequently required is the use of linker molecules. These molecules are chemically linked to the inner layer and serve to bind atoms, ions, atomic or molecular clusters of the conducting shell to the inner layer. The conducting shell atoms that bind to the linkers are used as nucleation sites for reduction of the additional atoms or molecules to complete the shell. One method used to attach gold particles to silicon dioxide is to treat the particles with aminopropyltriethoxy silane (APTES). The silanol end groups of the APTES molecules attach covalently to the silica core extending their amine groups outward as a new termination of the particle surface.

In this method, 10 ml of a silica particle suspension is added to a 50 ml glass beaker. Next, pure aminopropyltriethoxy silane (APTES) is added to the solution. Based on estimates, enough silane is added to coat the particles with multiple layers of silane. For example, 40 microliters of undiluted APTES can be used for particles having diameters of 120 nm. The solution is stirred for 2 hours, followed by dilution to 200 mls and then heated to a boil for four hours. The heating step promotes the reaction of silanol groups into Si—O—Si bonds and strengthens the attachment of the silane to the silica. This mixture is then centrifuged at 2000×g for 30 minutes. The supernatant is decanted off and the pellet redispersed ultrasonically. The washing procedure is repeated five times.

Many linker molecules other than aminopropyl triethoxy silane are suitable for use in this procedure. For example, aminopropyl trimethoxy silane, diaminopropyl diethoxy silane, or 4-aminobutyl dimethylmethoxysilane and the like can be used. In addition, the surface can be terminated with a linker that allows for the direct reduction of metal atoms on the surface rather than through a metallic cluster intermediary. In other embodiments, reaction of tetrahydrothiophene(AuCl) with a silica core coated with diphenyltriethoxy silane leaves a surface terminated with gold chloride ions which can provide sites for additional gold reduction. In other embodiments, a thin shell of another nonmetallic material, such as cadmium sulfide or cadmium selenide grown on the exterior of a silica particle allows for a metallic shell to be reduced directly onto the nanoparticle's surface. In other embodiments, functionalized oligomers of conducting polymers can be attached in solution to the functionalized or nonfunctionalized surface of the core nanoparticle and subsequently cross-linked by thermal or photo-induced chemical methods.

### Exemplary Embodiment 9

### Attachment of Metal Clusters

Metal clusters are attached to the linker molecules on the core by immersing the derivatized core particles in a metal colloid bath. Any metal that can be made in colloidal form could be attached as a metal cluster. For example, coinage metals, noble metals, transition metals, aluminum, synthetic metals and alloys thereof and indium-tin oxide (ITO) and the like can be used. In addition, metal-like organic molecules are suitable. Such compounds include polyacetylene and polyaniline. Gold clusters having a diameter of 1-3 nm are grown using the reduction reaction as described by Duff et al. (Langmuir 9:2310-2317 (1993)), incorporated herein by reference to the extent such methods are disclosed. A solution of 45 ml of water, 300 microliters of 1 M NaOH and 1 mL of a freshly diluted 1% aqueous solution of tetrakis(hydroxymethyl)phosphonium chloride (THPC) is stirred in a 100 ml flat bottom beaker with a pyrex coated magnetic stir bar. After 2 minutes, 2 ml of chloroauric acid (25 mM dark-aged stock solution, hydrogen terachloroaurate (III) trihydrate 99.999% from Aldrich) is added. This reaction mix is used to form gold particles in solution with an average particle diameter of 1-2 nm. To increase the size of the particles higher concentrations of gold chloride could be used. Particles prepared in this fashion are referred to as ultra small gold particles or (UG).

Generally, the UG solution is mixed with silica particles in an amount that would theoretically cover the core particle surface five to ten times. The solution is allowed to react for 3 hours under gentle stirring. In the preferred embodiment the gold is used 5-30 days after it is made.

Typically, after three hours, unreacted gold colloid is separated from the gold-decorated silica particles by centrifugation at 1000 RCF. The minimum amount of centrifugal force required to effect separation is used to avoid coalescence of the particles. Particles are washed twice by resuspension and centrifugation.

Various protectants can be added before centrifugation to facilitate later resuspension of the particles. These protectants include polyvinyl alcohol, polyethylene glycol or phosphine ligands, and thiol-terminated carboxylic acid linkages. Resuspension is accomplished when a minimum amount of force is used in the centrifugation step and any aggregates of particles are redispersed by treatment with sonification. A dynamic light scattering instrument is used according to standard and well known methods to verify that the particles are dispersed. The dispersed particles are then diluted to 10 ml for use as a stock solution for the growth of the complete metal shell.

### Exemplary Embodiment 10

### Growth of a Metallic Shell

Metal clusters can be enlarged by deposition of gold using a variety of reductants such as hydroxylamine hydrochloride, sodium borohydride, and formaldehyde. Formaldehyde is preferred. A solution of 25 mg anhydrous potassium carbonate is added to 100 ml of water containing 1.5 ml of 25 mM chloroauric acid solution (PCG). This solution is allowed to age in the dark for one day. Approximately 10 m+/−5 ml of PCG is then rapidly stirred with 2-5 mls of the gold clustered silica solution. A 100 ml aliquot of freshly prepared formaldehyde solution (2% by volume in water) is slowly added.

Prior to enlargement of the metal clusters, the metal clusters attached to the particles have the same UV-visible absorption spectrum as their natural colloidal form. As additional metal is deposited onto the clusters, the absorbance maximum of the particle shifts to longer wavelengths. When the gold shell is complete, the particles' absorbance maximum is related to its geometry, specifically, to the ratio of the thickness of the inner nonconducting layer to the thickness of the outer conducting layer. As the conducting layer grows thicker, the absorbance maximum of the particle shifts to shorter wavelengths. The progress of the reaction is followed spectrophotometrically and terminated when the desired wavelength for the absorbance maximum is obtained. Typically a color change occurs within 10 minutes. For 110 nm diameter core particles, typically a visible color change is apparent, from faint brown to purple, blue, green, or yellow. Some of the other factors that influence the optical absorption of the spectrum are the size of the core, the roughness of the shell, the shape of the core, additional reactants in solution that may be incorporated into the core during the reduction, the continuity of the shell, and the degree of aggregation of the particles.

Many different methods can be used to complete the metal shell once the nucleation sites are in place. One of skill in the art will realize that any method that can be used to develop a metal colloid into a larger metal colloid should be successful for the shell growth. For example, silver solutions such as the commercially available LI silver from Nanoprobes, Inc. can work. In addition, it is not necessary that the tethered seed particle be of the same material as the shell material. In one embodiment silver nitrate is reduced onto silica coated with UG. This is done in a basic solution with formaldehyde as a reductant and results in a silver shell. Photo-induced deposition of the metal shell onto the prepared nanoparticle surface is also possible.

Direct reduction of silver onto a non-conducting core can be accomplished with the reduction of silver directly onto a cadmium sulfide semiconductor layer. In order to construct a cadmium sulfide with a diameter greater than 20 nm it is necessary to first grow a cadmium sulfide layer onto a silica core. This can be accomplished using water in oil microemulsions, for example. In one embodiment silver is reduced onto a silica/cadmium sulfide particle by adding the particles to a solution of silver nitrate (AgNO₃) and ammonium (NH₄) and then slowly adding a NH₃OHCl (hydroxylammonium chloride) solution to develop the shell.

Those who are skilled in the art will appreciate that the above-mentioned procedures can be applied to glass, metal and composite particles whose surfaces comprise artificial features which include, but are not limited to, chemical, metallic, etched or porous surface modifications. The surface of silicon can also be roughened mechanically or chemically to have a surface roughness of nanometer to micrometer scale.

While the foregoing specification teaches the principles of the present invention, with examples provided for the purpose of illustration, it will be appreciated by one skilled in the art from reading this disclosure that various changes in form and detail can be made without departing from the spirit and scope of the invention.

What is claimed is:

1. A method of immobilizing a bead to a substrate comprising:
a.) providing at least one bead with a clean surface;
b.) silylating the bead surface;
c.) reacting the silylated bead surface with at least one poly(ethylene oxide), wherein a hydrated poly(ethylene oxide) bead surface is formed;
d.) providing a functionalized substrate surface; and
e.) reacting the functionalized substrate with the hydrated poly(ethylene oxide) bead surface;
wherein the bead is immobilized to the substrate.

2. The method of claim 1, wherein the functionalized substrate surface is glass.

3. The method of claim 2, further comprising reacting the glass substrate surface with a cyclopentadiene agent, wherein a cylopentadiene-functionalized glass substrate surface having a maleimide group is formed.

4. The method of claim 1, wherein soaking in a solution cleans the surface.

5. The method of claim 2, wherein the solution is Piranha Solution.

6. The method of claim 2, further comprising sonicating.

7. A method of forming a hydrophilic surface on a particle having a plasmon resonance comprising:
a.) providing at least one substrate particle surface;
b.) chemically modifying the surface; and
c.) reacting the modified surface with at least one functionalized poly(ethylene oxide);
wherein a hydrated poly(ethylene oxide) substrate particle surface is formed.

8. The method of claim 7, wherein the plasmon resonance is formed by:
(a) attaching a plurality of linker molecules to the substrate particle;
(b) attaching a preformed metal nanoparticle to each of at least a portion of said linker molecules;
(c) reducing additional metal onto the metal particles so as to form a substantially continuous metal shell encapsulating each substrate particle; and
(d) selecting the conditions of step (c) such that the shell has a controllable thickness.

9. The method of claim 8, wherein said metal shell comprises a metal selected from the group consisting of gold, silver, palladium, platinum, aluminum, lead, iron, copper and alloys thereof, indium-tin oxide (ITO), coinage metals, noble metals, transition metals, synthetic metals, and alloys thereof, diamond, and carbon nanotube.

10. The method according to claim 8, wherein step (c) comprises growing the metal nanoparticles into the shell.

11. The method according to claim 8, wherein each of steps (a), (b) and (c) is carried out in solution.

12. The method according to claim 8, wherein the metal is selected from the group consisting of gold, silver, palladium, platinum, aluminum, lead, iron, copper and alloys thereof, indium-tin oxide (ITO), coinage metals, noble metals, transition metals, synthetic metals, and alloys thereof, diamond, and carbon nanotube.

13. The method according to claim 7, wherein the substrate particle comprises an oxide compound and the linker molecule comprises a silane.

14. The method according to claim 13, wherein the silane is selected from the group consisting of aminopropyltriethoxy silane, aminopropyltrimethoxy silane, diaminopropy-diethoxy silane, 4-aminobutyldimethylmethoxy silane, and mercaptopropyltrimethoxy silane.

15. A method for selectively attaching particles to a substrate surface, the method comprising:
providing a substrate surface configured to receive a plurality of particles;
introducing the plurality of particles onto the substrate surface; and
immobilizing the plurality of particles to the substrate surface by a selectively triggered reaction.

16. The method of claim 15 wherein selectively triggering immobilization of the plurality of particles to the substrate surface is effectuated following ordering of the particles on the substrate surface in a desired particle configuration.

17. The method of claim 16 wherein prior to selectively triggering immobilization of the plurality of particles to the substrate surface the position of the particles is manipulated, additional particles are added to the substrate surface, or particles are removed from the substrate surface to achieve the desired particle configuration.

18. The method of claim 15 wherein the selectively triggered reaction comprises a click reaction.

19. The method of claim 18 wherein the click reaction is based on a mechanism selected from the group consisting of: copper-based catalytic reactions, thermally triggered reactions, difluorinated cyclooctyne-based reactions, hydrophilic azacyclooctyne-based reactions, and azide-alkyne cycloaddition covalent modification reactions.

20. The method of claim 15 wherein the selectively triggered immobilization of the plurality of particles to the substrate surface results in an ordered array of particles.
